(19) United States
(12) Patent Application Publication
(10) Pub. No.: US 2013/0038624 A1
(43) Pub. Date: Feb. 14, 2013

(54) METHOD AND APPARATUS FOR RENDERING ANTI-ALIASED GRAPHIC OBJECTS

(71) Applicant: Isao NAKAJIMA, Suginami-ku (JP)

(72) Inventor: Isao NAKAJIMA, Suginami-ku (JP)

(21) Appl. No.: 13/469,686

(22) Filed: May 11, 2012

Related U.S. Application Data
(63) Continuation-in-part of application No. 13/206,804, filed on Aug. 10, 2011.

(51) Int. Cl. G09G 5/02

(52) U.S. Cl. 345/592; 345/589

(57) ABSTRACT

The invention provides a method and an apparatus for displaying anti-aliased graphic objects. Subpixels are generated with two different memories including the one for alpha masking and the other for color storage, and function as a small virtual bitmap in which each position (i.e. subpixel) is set to be stainable on a one-off basis at every frame update. If plural objects share an identical pixel, the virtual bitmap for the pixel is to be filled gradually in forward-to-rearward order, reflecting the accurate objects' intensities. Transparent representation is processed via determination of active subpixels smaller in number than the number of subpixels, thereby shrinking the coverage of rendering objects in respective pixels. These active subpixels are selected with bit masks, and plural bit masks are provided to control transparent levels of rendering objects.

### CROSS-REFERENCE TO RELATED APPLICATIONS

This application claims priority to and is a continuation-in-part of U.S. application Ser. No. 13/206,804, filed Aug. 10, 2011, which is incorporated herein by reference in its entirety.

### BACKGROUND OF THE INVENTION

In computer graphics, graphic objects including glyphs, polygons or primitives are displayed through minimum displayable dots called “picture elements” or “pixels”. The pixels are normally aligned to luminous grids on the video output device, and graphic objects are rendered by distributing their foreground colors to those pixels exhibited in intended locations. Inevitably in this method, the frequency in grids i.e. resolution largely affects the qualities of graphics, and to reduce the granularity visible in low resolution, a method called “anti-aliasing” is processed. The skills of anti-aliasing are aimed to moderate the gap between the substantial resolution provided through the video output device and the expected resolution to display the graphic data targeted. And, it is possible to categorize the skills into two types. The first one is focused on how to blend pixel values sampled from those in the expected resolution. The obvious example in this art is rendering photograph in different scales. And the second one is a method to work on respective graphic elements that include the alpha channel of rendering objects. The skill in this art is illustrated in FIG. 1. A small tilted black rectangle is put on the white background. The sloped line 101 is not smooth, causing aliasing effect or “jaggy” along the edges. By providing the gradients in gray scale, the lines are exhibited with smooth edges as 102. In the latter type of anti-aliasing, graphic objects are often enlarged at a preferable size to zoom in the coverage of objects in respective pixels. This manipulation in scaling is practiced via the definition of coordinate space swelled with virtual pixels within respective pixels. These virtual pixels called “subpixels” are further smaller than physical pixels, and the subpixels' matrix are commonly represented with a bit array just like a bit map image represented with an array of units. Subpixels 103 indicate that 6 subpixels out of 16 subpixels are covered with the “enlarged” rectangle object, and this situation is consulted in the determination of the gradational level assigned to the pixel. This typical technique of counting the covered subpixels belongs to the prior art referred to as “super sampling”, and the resulted gradational level is often called “color intensity”. Ultimately, the pixels values for objects' edges are determined by blending the foreground color and the background color in accordance with the color intensities attained through the enlarged coordinate space. When the color intensity Ci is naturalized, the equation is to be:

pixel value=Ci×forecolor+(1−Ci)×backcolor

In this manner, the reduction of aliasing effects is embodied. The present invention is based on this super sampling technique. While the art called “super sampling” is embodied through various anti-aliasing methods beyond the above categories, the super sampling in this text indicates the introduced skill processed with alpha channel masks.

In the prior art described, pixel values are determined entirely with the blending ratio between the foreground color and the background color, but this method may bring about inaccurate results when plural objects are rendered simultaneously. Introduced below is the process to determine a pixel value, comparing to a blend of three different coffees that include Kilimanjaro, Mocha, and Brazil. The background color is supposed to be green, which is described as a coffee cup filled with, say Kilimanjaro by 200 cubic centimeters. Then, suppose the pixel is covered the 50 percent on the right side with a red object “R” such as:
GR
GR

At this point, the pixel value is to be determined as 50 percent red and 50 percent green. The 100 cc of Kilimanjaro is poured into the sink, and the same amount of Mocha representing red is poured into the cup. The Kilimanjaro poured into the sink means the subtraction of Ci×backcolor in the below equation, and Ci×forecolor is poured into the cup to maintain the total volume.

pixel value=Ci×forecolor+(backcolor−Ci×backcolor)

Then, suppose another blue object “B” is placed to cover 50 percent of the same pixel, this time on the left side.
BR
BR

The equation between the foreground blue and the “updated” background color results in 50 percent blue, 25 percent red and 25 percent green. This means that the 100 cc of the current blend (with Kilimanjaro and Mocha) is poured into the sink, and the same amount of Brazil representing blue is poured into the cup. The pixel has been covered with red on the right side and blue on the left side, and the background green should not be visible in this case. Yet, the 50 cc of Kilimanjaro representing green remains in the coffee cup. As a variation of this example, suppose the second one, the blue object B, is placed on the same side with the red object overlaying the red object in the half plane on the right side such as:
GB
GB

The equation done with the blending ratio results in the same value as in the previous example, but the expected pixel value should be 50 percent blue and 50 percent green. A more complex case is when the red object and the blue objects are characterized to have transparencies, traversing the pixel in various manners rather than covering either 50 percent half plane where the two objects partly overlap. Thus, the information for blending ratio is not sufficient to represent these situations.

### SUMMARY OF THE INVENTION

In the present invention, the coffee cup is not filled on every occasion as alpha blending is processed. Instead, a plurality of small coffee cups are provided by the subpixels' count. When an object's silhouette covers an intended pixel, those small cups under the covered area are filled with a corresponding coffee, and once the small cups are filled, the cups will be masked so that it becomes impossible to pour another coffee into the filled cups. For example, at 2A in FIG. 2, about 50 percent of cups are filled with the first silhouette, and an attempt is made to render the second silhouette represented with 2B, but it is to be done only with the vacant cups in 2A. Consequently, the coverage of the second silhouette becomes 25 percent of the intended pixel as with 2C. As two cups are left vacant in 2C, the coffee cups are not filled at all on every occasion as a bland new coffee is poured into the cups, which means, the equation to fill the coffee cup, <pixel value=Ci×forecolor+(1−Ci)×backcolor> is not processed in the present invention. In the conservative method introduced, the proportion of the blending ratio is altered as a new coffee is poured into the cup. For example, the 100 cc of Mocha assigned to an intended pixel is not necessary to reflect the proportion of Mocha in the final blend because its proportion will be decreased when a bland new coffee is poured into the cup. Yet in 2C, the first and the second silhouettes represent their proportions in the final blend, and the pixel value is to be determined after the rest of the two vacant cups are filled out.

The introduced process is embodied with additional memory to define blank area in each pixel, which is provided in the subpixels' format. All bits in the subpixels are initialized to be blank area, and as any contour of graphic object traverses, the subpixels under the covered area are inverted to represent stained area. These inverted subpixels are excluded from the subsequent rendering via comparison between the workspace for super sampling and the subpixels representing the blank area. When plural objects share an identical pixel, the above procedure is to be processed on the pixel by the objects' count where the coverage of each object is determined within the shrinking blank area in the pixel. Inevitably, the objects are rendered in forward-to-rearward order, and this rendering order is a characteristic of the present invention. The color values representing each object's coverage are accumulated on another memory provided as color storage, and pixel values are determined after the pixels are fully stained. In this process, the stained subpixels' count and the volumes of color values accumulated on the color storage synchronize where the expected total volumes of color values reflect the number of subpixels. The expression, “color value”, in this text indicates preferably a set of color component values such as RGB, and its accumulation can mean a set of summed color component values, but these are not limited thereto. However, since the number of subpixels is defined to be a power of 2, the determination of pixel values can be made efficiently with offset controls on the color values accumulated on the color storage.

Thus, the introduced method is simple, accurate and relatively fast, but it consumes a substantial amount of memory. In the present invention, at least 32 subpixels, or preferably 64 subpixels, are provided by the amount for the largest bounds to work on, and these subpixels are associated with corresponding memories for color storage. Considering the fact that the alpha blending in the above flow is processed mostly for the pixels on objects' edges, the introduced method might not be superior in terms of memory efficiency. Still, several Mbytes of workspace, or twice much of the amount would not be a serious burden for those memory devices coupled to recent computers. A more difficult problem in the discussed method lies in the representation of transparent objects. It is no longer possible to alpha-blend the color values accumulated on the color storage.

In the present invention, transparent rendering is processed through additional bit filtering. Suppose the case in which a transparent object represented by Mocha is covering an entire pixel where the background color is represented by Kilimanjaro. Since objects are rendered in forward to rearward order in the present invention, the Mocha is poured into the cups first, but if the object's silhouette is filtered through bit mask 2D in FIG. 2 for example, the Mocha is poured only into nine cups as with 2E. Whereas in rendering the opaque background, the bit filtering for transparent rendering is not processed, and the Kilimanjaro is poured into the rest of seven cups. As a result, the pixel value becomes a blended value between the two different coffees, Mocha and Kilimanjaro. As for rendering plural transparent objects, the layouts of filtering points are altered in accordance with the rendering order. When a transparent object is rendered subsequently to the Mocha object at 2E, the layout of filtering points becomes for instance as 2F. The numbers of filtering points in the two layouts, 2D and 2F are identical at nine points, but since the filtering points of the two bit masks overlap in part, the coffee for the second silhouette is poured only into 4 cups as with 2G. In the transparent representation, the object in the forefront should be more visible than the object in the background, and the filtering points of the two bit masks are partly overlapped to represent this nature. When the filtering points and the masked points are expressed with “1” and “0”, the relationship between 2D and 2F can be displayed as follows:

2D: 1111 1111 1000 0000

2F: 0000 1111 1111 1000

The bit order in the above alignment is simplified to describe the situation. Five filtering points are overlapped, and four filtering points of 2F beneath 2D are effective. In the present invention, the relationship between the two bit masks is comprehended as such that the nine filtering points in 2D are moving to their next positions for the subsequent filtering at 2F such as:

2D: ABCD EFGH 1000 0000

2F: 0000 ABCD EFGH 1000

In the above example, each filtering point is individually marked to identify its movement, and a notion of moving paths for filtering points is taken on in designing the bit masks. The resulted bit masks are called “layers”, and plural layers are fabricated to control the transparent levels of rendering objects. These layers overlap themselves fractionally in a predetermined sequence, forming a hierarchal structure through which the backgrounds' visibilities are reduced in accordance with the layers' accumulated volumes. Transparent levels are selective via determination of the number of the layers to be applied, and by having consecutive layers combined in desired volumes, filter sets for different levels of transparency are constructed. Since these filter sets are assembled from the same original layers, it is possible to use them together in the same frame. The ON status positions of each layer are compared to available coffee cups in FIG. 2, but in the explanation of the layers' structure, the ON status positions hereafter are referred with a different notion as “signals”.

The above method for the transparent representation has an unusual effect. Those objects being filtered through the same bit mask do not transmit their appearances each other, and it is possible to make a group of objects sharing the same layer in the hierarchy. For example, if the second silhouette following to 2E is filtered with the same bit mask of 2D, the second silhouette beneath the first silhouette will not be displayed. This technique effects to represent unified translucent entities, as well as the focus amongst vastly displayed graphic objects.

As is described, the layout of filtering points for transparent rendering is an important factor in the present invention. The difficulties in designing the sampling points' layout are revealed in U.S. Pat. No. 6,501,483 with a first listed inventor of Wong.

An object of the present invention is therefore to actualize rendering anti-aliased graphic objects by a method which is simple, accurate and relatively fast, as well as to provide an apparatus thereof.

In one embodiment, the present invention's method for rendering anti-aliased graphic objects comprises: providing first memory to represent blank area in each pixel, having 2^{N} bits of subpixels where N is at least 5, in which memory, ON status bit indicates unstained position in the subpixels' matrix wherein ON and OFF are defined normally 1 and 0, but if alternative setting is preferred, AND operation and OR operation should also be swapped throughout corresponding process, the first memory initialized to be ON status in full; providing second memory to store accumulation of color values corresponding to the first memory, capable of storing 2^{N} volumes of accumulation of color values reflecting the number of subpixels wherein the amount of stained subpixels in the first memory and the volumes of the accumulation of color values in the second memory synchronize; and processing scan conversion in forward-to-rearward order, wherein the order is to be determined on either object-by-object basis or pixel-by-pixel basis, comprising: a step for determining sampling points inside an area to be covered with an intended graphic object; a step for inverting corresponding subpixels in the first memory to OFF status; and a step for adding corresponding color values to the second memory by the amount of successfully inverted subpixels in the first memory wherein after all subpixels in a pixel are inverted to OFF status, pixel value for the pixel is to be determined by color values accumulated on the second memory.

In the above, “adding corresponding color values to the second memory by the amount of successfully inverted subpixels in the first memory wherein after all subpixels in a pixel are inverted to OFF status, pixel value for the pixel is to be determined by color values accumulated on the second memory” corresponds to, for example, 103 in FIG. 1, but not necessarily limited thereto.

In another embodiment, in the method, the first memory to be initialized can be selected from an updating area(s) in the whole image, and the first memory for outside the updating area(s) may be set to be in fully OFF status thereby the updating area(s) is clipped.

In yet another embodiment, the method above can comprise a step of providing filter objects with which sampling points are filtered, thereby shrinking coverage of rendering objects in respective pixels.

In another embodiment, determining sampling points inside an area to be covered with an intended graphic object comprises a step of filtering sampling points via the filter objects if transparent rendering is desired.

In yet another embodiment, wherein providing filter objects comprises further steps of: providing plural layers of bit masks which form a rotational hierarchy in a way where the subpixels are defined as a plurality of signal paths on which ON status positions of each layer move sequentially in accordance with the layers' order wherein lengths of the signal paths are set to be the total number of layers or the factor thereof; and providing filter objects comprising one or more than one layer(s) from the plural layers wherein the number of layers comprised in each filter object correspond to a desired level of transparency, the filter objects comprising variations of filter objects being characterized in the same transparent level, each corresponding to respective layers in the hierarchy.

in another embodiment, in the method, the first memory includes at least two 4×4 regions, the 4×4 regions defined as a set of 4 linear segments respectively, each linear segment consisting of 4 subpixels lined diagonally within a rotational 4×4 matrix, the 4 linear segments in a respective 4×4 region overlapping in no position, sharing the same diagonal line slope.

In yet another embodiment, in the method, an amount of signals i.e. ON status positions for each layer is K=2^{N}/4 indicating each layer's opacity being set at one fourth.

in another embodiment, in the method, K/4 signals are distributed uniquely to K/4 signal paths, and 3K/4 signals are distributed substantially uniformly to K/4 signal paths where three signals reside par a path.

In yet another embodiment, in the method, each signal path for three signals is placed on two linear segments in a respective 4×4 region, the two linear segments being adjacent to each other within the rotational 4×4 matrix for a respective 4×4 region.

In another embodiment, in the method, the three signals are forming an absolute radian R=π/2+2×tan⁻(0.5) in a supposed coordinate space consisting of 2×2 copies of an original 4×4 region where one signal for a peak point is placed on one linear segment and two signals for two end points are placed on the other linear segment.

In yet another embodiment, in the method, intervals in the three signals include two odd intervals, and four path points in even indexes and four path points in odd indexes are separately assigned to either of the two linear segments, wherein the indexes assigned to the two linear segments proceed in the same direction respectively.

In another embodiment, in the method, a pair of different sets of signals' intervals is provided for every two signal paths for three signals, wherein intervals whose length include 1, 2, and 3 are assigned to either of the two signal paths, and the number of intervals for each type is identical.

In yet another embodiment, in the method, a positional gap between even indexes and odd indexes in the two linear segments for three signals is determined to form the absolute radian R in accordance with signal intervals being assigned, wherein the radian turns alternatively between positive R and negative R as index proceeds alternating its peak point's position in between the two linear segments for three signals.

In another embodiment, in the method, two linear segments in a respective 4×4 region are reserved for signal path for single signal, consisting of mirrored peak points, each of which form a mirrored radian R with corresponding two end points for an original of the radian R formed with the three signals.

In yet another embodiment, in the method, the mirrored radian R turns alternatively in positive and in negative as index proceeds, and four points in even indexes and four points in odd indexes are separately positioned to either of the two linear segments for single signal.

In another embodiment, in the method, each signal path for single signal consists of two linear segments from two different 4×4 regions, wherein every two paths for single signal are mapped over every two 4×4 regions, including first and second paths, the second path(s) being reserved as editable area, and assignments of even indexes and odd indexes alternate between the first and second paths in every two 4×4 regions.

In yet another embodiment, in the method, the editable path(s) is/are to be optionally divided into shorter paths whose length are factor(s) of the total number of layers, the shorter paths including signal path for no signal i.e. an area reserved for a background view.

In another embodiment, in the method, proceeding directions of signal paths are determined to counterbalance with each other when the subpixels comprise four or more 4×4 regions.

In yet another embodiment, in the method, ID bit for each layer is defined in favor of layout of the first path(s) for single signal wherein those bits on the first path(s) are traveled to align successively in respective bit positions for ID bits via two operations with predetermined values comprising: multiplier(s) with which corresponding part(s) of those bits on the first path(s) is/are multiplied to form successive bit segment(s) in desired order(s); and offset value(s) with which the successive bit segment(s) is/are shifted to align in respective bit positions for ID bits.

In another embodiment, in the method, yet-to-be-applied layers' IDs for an intended pixel are assembled into a bit array called applicable ID holder, comprising the steps of: (1) assembling ID bits from the respective first path(s) for single signal via the two operations on the first memory for an intended pixel; (2) processing AND operation between/among the resultants of (1) when a plurality of the first paths exist; and (3) processing OR operation between/among the resultants of (1) when the resultant of (2) does not include an expected amount of layer's IDs.

In yet another embodiment, in the method, look-up table(s) is/are provided to identify appropriate layer(s) to be applied to intended pixels, having entries for all possible variations of the applicable ID holder, the look-up table(s) representing priorities' order including: (1) when partitions exist in applicable layers' order where the layers' order is rotational, selecting a layer(s) designated with ID bit(s) in the smallest partition; (2) when a plurality of applicable layers are aligned consecutively where the layers' order is rotational, selecting a layer(s) designated with ID bit(s) in the first part of the alignment; and (3) selecting a layer(s) in accordance with applicable layers' order.

In another embodiment, in the method, filtering the sampling points via the filter objects comprises further steps of: attaining an applicable ID holder for an intended pixel; and identifying a filter object(s) to be applied to the intended pixel via one from the look-up table(s) with the applicable ID holder.

In yet another embodiment, in the method, attaining an applicable ID holder for an intended pixel via one is done by one of three methods specified as; (a) attaining the applicable ID holder from the first memory for the intended pixel; (b) attaining the applicable ID holder from a memory space provided to store applicable ID holder for each pixel wherein the stored applicable ID holder is initialized to include all layers' ID bits, and when any layer is applied, its ID bit is to be inverted, wherein in case where applicable layers indicated in the stored applicable ID holder are not sufficient for desired filtering, the stored applicable ID holder is to be reassembled from the first memory for the intended pixel; and (c) attaining the applicable ID holder for grouped objects, the ID holder being generated by: an act for providing group ID for each objects' group designated to share the same layer(s); an act for providing a memory space for each pixel for storing the group ID and an applicable ID holder for objects' group, wherein the memory space is to be updated with the last filtered object holding an unknown group ID; and an act for comparing a group ID stored in the memory space with that of a rendering object wherein in case where the group ID stored in the memory space is identical to the group ID for the rendering object, the applicable ID holder stored for objects' group is to be the one for the intended pixel, otherwise an applicable ID holder is attained via the (a) or the (b), thereby updating the memory space with the group ID for the rendering object and the attained applicable ID holder.

In order to attain the aim above, the present invention is actualized as an apparatus for rendering anti-aliased graphic objects, the apparatus comprising: a first memory to represent blank area in each pixel, having 2^{N} bits of subpixels where N is at least 5, in which memory, ON status bit indicates unstained position in the subpixels' matrix wherein ON and OFF are defined normally 1 and 0, but if alternative setting is preferred, AND operation and OR operation should also be swapped throughout corresponding process, the first memory initialized to be ON status in full; a second memory to store accumulation of color values corresponding to the first memory, capable of storing 2^{N} volumes of accumulation of color values reflecting the number of subpixels wherein the amount of stained subpixels in the first memory and the volumes of the accumulation of color values in the second memory synchronize; and a scanning part in which scan conversion is processed in forward-to-rearward order, wherein the order is to be determined on either object-by-object basis or pixel-by-pixel basis, wherein: sampling points are to be determined inside an area to be covered with an intended graphic object; corresponding subpixels in the first memory are to be inverted to OFF status; and corresponding color values are to be added to the second memory by the amount of successfully inverted subpixels in the first memory wherein after all subpixels in a pixel are inverted to OFF status, pixel value for the pixel is to be determined by color values accumulated on the second memory.

In another embodiment, in the apparatus above, filter objects are to be provided with which sampling points are filtered, thereby shrinking coverage of rendering objects in respective pixels; and wherein determining sampling points inside an area to be covered with an intended graphic object comprises filtering sampling points via the filter objects if transparent rendering is desired.

### BRIEF DESCRIPTION OF THE DRAWINGS

FIG. 1 illustrates typical super-sampled alpha channel mask in prior art.

FIG. 2 illustrates how subpixels are utilized in accordance with the present invention.

FIG. 3 illustrates two triangles as the resources to demonstrate the methods of rendering objects in accordance with the present invention.

FIG. 4 illustrates how to render an object in the foreground in accordance with the present invention.

FIG. 5 illustrates how to render an object in the background in accordance with the present invention.

FIG. 6 illustrates the basics to filter sampling points to render transparent objects in accordance with present invention.

FIG. 7 illustrates the definition of 4×4 regions and linear segments in the respective 4×4 regions.

FIG. 8 illustrates positional relationship of three points gapped each other in either coordinate in X or Y direction.

FIG. 9 illustrates radian R formed with the positional relationship of the three points in FIG. 8

FIG. 10 illustrates the first example of positional order and intervals of ON status positions' allocations that form the radian R.

FIG. 11 illustrates the second example of positional order and intervals of ON status positions' allocations that form the radian R.

FIG. 12 illustrates hierarchal structure formed in accordance with the positional order and intervals of ON status positions' allocations introduced in FIG. 10 and FIG. 11.

FIG. 13 illustrates how to counterbalance the positional order of ON status positions' allocations.

FIG. 14 illustrates examples of the positional order of ON status positions' allocations.

FIG. 15 illustrates how to determine the positional order of ON status positions' allocations assigned to 4×4 regions.

FIG. 16 illustrates examples of ON status positions' layouts for original eight layers.

FIG. 17 illustrates how ON status positions of the last layer shift and reduce in accordance with the accumulation of the original eight layers introduced in FIG. 16.

FIG. 18 illustrates redefinition of the positional order of ON status positions' allocations introduced in FIG. 14.

FIG. 19 illustrates an example to make partitions in the positional order of ON status positions' allocations introduced in FIG. 18.

FIG. 20 illustrates examples of ON status positions' layouts for 75 percent transparent filters.

FIG. 21 illustrates how ON status positions of the last filter shift and reduce in accordance with the accumulation of the 75 percent transparent filters introduced in FIG. 20.

FIG. 22 illustrates examples of ON status positions' layouts for 50 percent transparent filters.

FIG. 23 illustrates how ON status positions of the last filter shift and reduce in accordance with the accumulation of the 50 percent transparent filters introduced in FIG. 22.

FIG. 24 illustrates how ON status positions of the last filter shift and reduce in accordance with the accumulation of the 25 percent transparent filters.

FIG. 25 illustrates errors in 75 percent transparent filtering done with filters introduced in FIG. 20.

FIG. 26 illustrates errors caused with the mixed use of two types of transparent filters introduced in FIG. 20 and FIG. 22.

FIG. 27 illustrates bit operations to package key bits for respective layers into eight bits of layer IDs.

FIG. 28 illustrates a basic logic to construct look-up table to select the transparent filters.

FIG. 29 illustrates basic logics to construct look-up table to select the 75 percent transparent filters.

FIG. 30 illustrates irregularly filtered patterns that need to be referred in constructing look-up table to select the 50 percent transparent filters and the 25 percent transparent filters.

FIG. 31 illustrates examples of logics to select layers for 50 percent transparent filtering.

FIG. 32 illustrates examples of bit masks that function as default filters.

FIG. 33 is the flowchart to select filters for intended pixels.

FIG. 34 illustrates grouping of transparent objects.

FIG. 35 is the flowchart to render groups of transparent objects.

### DETAILED DESCRIPTION

The present invention demonstrates a method/apparatus to render a plurality of graphic objects through alpha channel masks. However, it is not concerned with the skills to create the masks for rendering objects themselves. It may be for glyphs, or 3D polygons. The process to define the coverage of each individual object as well as to provide the color values to be mapped to the defined area can be customized for various purposes, and it is possible to adopt customized procedures to the present invention. Then the discussion starts with the basic requirements in the present invention, which include those about subpixels' matrix, rendering order and memory usage.

In the present invention, the number of subpixels is defined to be a power of 2, and at least 32 subpixels are necessary to render transparent objects. The preferable size is 64 subpixels, and the example for the best mode is introduced at this size. The size of subpixels affects the rendering speed and the accuracy in the representation where the relationship between the two elements is a tradeoff. The size of subpixels also largely affects the amount of required memory. The subpixels' matrix consists of 4×4 regions, which means that the matrix for 32 subpixels should be either 8×4 or 4×8. As usual in the case for super sampling, the bit order for subpixels can be defined in a preferable manner. For example, the first bit in the subpixels' memory can point to any corner in the matrix. Exceptionally for 32 subpixels' environment, the longer side of the matrix should be represented by successive bits. For 8×4 matrix for instance, the first 8 bits in the memory should represent a horizontal line in the matrix, rather than two vertical lines. In the example for the best mode, the matrix is set to 8×8 of which the bit order can be freely defined. Throughout this text, the expression “ON status positions” often appears, and it usually means sampling points. Yet, since the word “sampling points” has been used in different manners, it is expressed more specifically with “ON”. Normally, “ON” indicates 1, and “OFF” indicates 0, but if the opposite setting is preferred, AND operation and OR operation in the introduced procedures should be swapped as well.

The scan conversion in the present invention is to be processed in forward-to-rearward order. The scan conversion in this text indicates preferably the procedures to scan the coverage of object in each pixel and convert the results into the color components' values, but these are not limited thereto. The order can be determined on either object-by-object basis or pixel-by-pixel basis.

As for the memory allocation, the present invention requires two workspaces in tolerable size for the largest bounds to work on. The two workspaces, first and second memories, correspond to respective pixels where the first memory is for the subpixels to define blank area, and the second memory is to store an accumulation of color values in the volumes reflecting the number of the subpixels. The second memory can be prepared in any format, but it needs to be done in respect to the accumulation process discussed below. In this text, the workspace for super sampling is referred to as the third memory. In case that the operations for super sampling are processed along pixel line by pixel line, the third memory should have a sufficient size for the pixel line length.

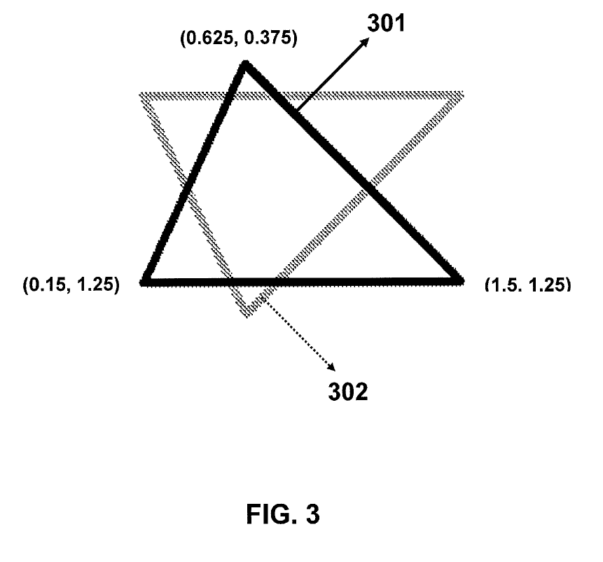

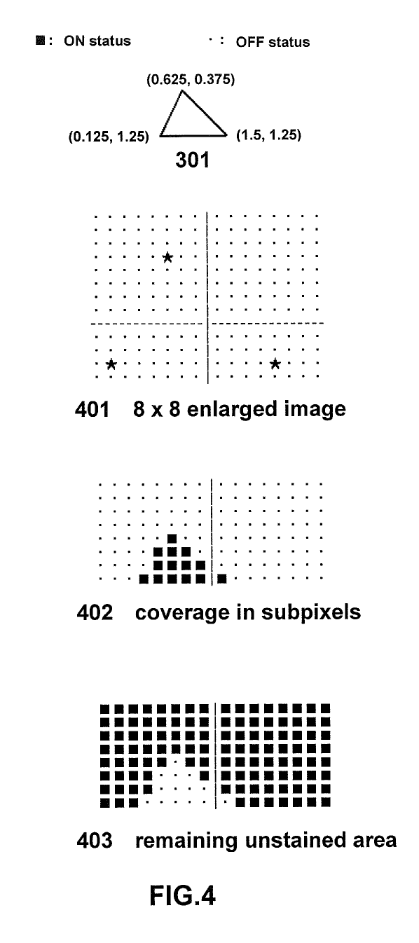

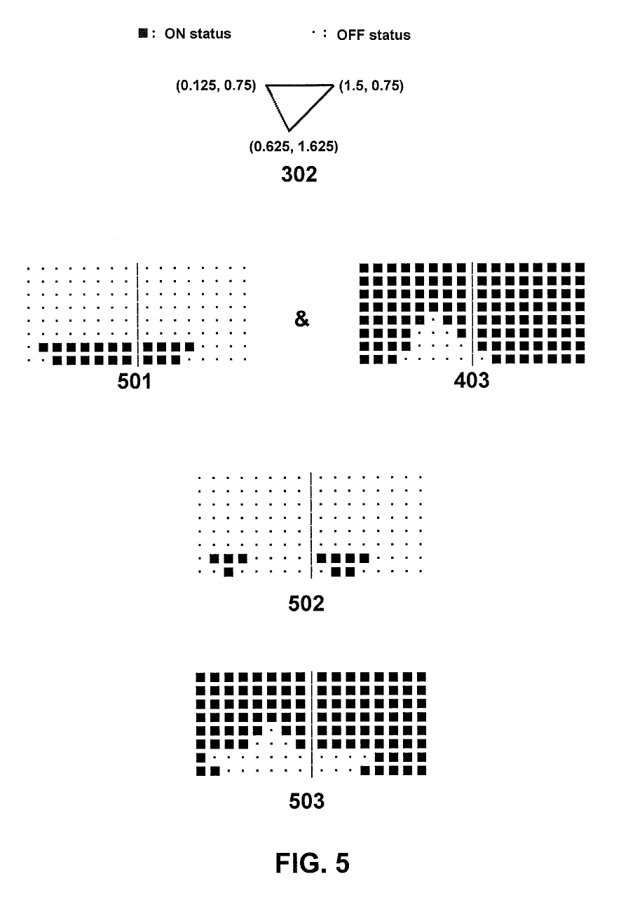

In the first memory, blank area is defined with ON status bits, and this memory is initialized to be entirely in the blank. The third memory is initialized to be fully in OFF status, and the bits in the third memory are inverted in a preferable manner where ON status bits indicate the covered area. For example, a small triangle 301 in FIG. 3 is enlarged 8×8 times in accordance with the subpixels' matrix as 401 in FIG. 4. The subpixels in the third memory are inverted for the pixel line on the top as 402. Then the third memory is to be AND operated with the first memory. Since the first memory has been fully in ON status, nothing happens to the third memory. The coverage of the triangle 301 in the pixel line is determined, and the determined area in the first memory is inverted to be a stained area as 403. Following to the triangle 301 is the triangle 302 whose first pixel line is to be represented in the third memory as 501 in FIG. 5. As in the case of the triangle 301, the third memory 501 is AND operated with the first memory 403, and this time, those bits behind the triangle 301 are excluded. The coverage of the triangle 302 on the pixel line is determined as 502, and the first memory is to be stained as 503. In this manner, the coverage of each object is determined, and once the coverage is determined, the color values reflecting the coverage is computed and added to the second memory. The number of stained subpixels and the volumes of color values accumulated on the color storage synchronize where the expected total volumes of color values reflect the number of subpixels. After a pixel is fully stained, the pixel value is determined with the color values accumulated on the second memory. Since the total volumes of color values reflect the number of subpixels, which is a power of 2, the pixel value can be retrieved via offset controls done by bit shifting. As common in art for super sampling, color intensities are computed primarily for the objects' edges. When the examined pixel is placed at the midpoint of an opaque object, where the pixel is covered with the object obviously in 100 percent, the required steps can be inserting fully OFF status value e.g. zero to the first memory, and putting a corresponding color value at the pixel's position in the frame buffer. On the other hand, the insertion of fully OFF status value to the first memory can be done for a practical use to clip the updating area(s). Those pixels whose first memory is set to the OFF status value at the initialization will not be updated as already stained area(s).

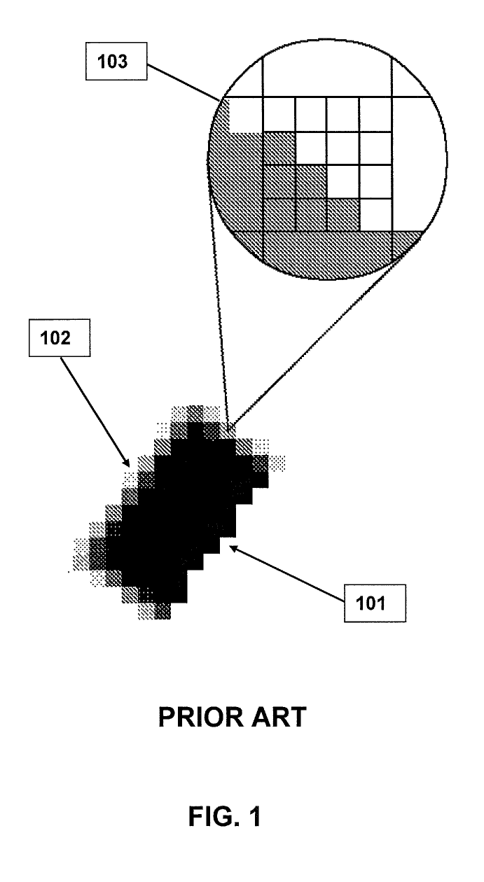

Logically, the introduced method is quite different from the conservative anti-aliasing. From a viewpoint, the virtual 2D space of the subpixels in the present invention can compare to a bit map image of which the amount of displayable color elements is fixed at the image size. The major difference between the two, however, is the capability to alter the color values. In the present invention, once a color value is assigned to a particular position in the subpixels' matrix, the color value assigned to the position is determined and never changed throughout the rendering process. The first memory's function is only to define the blank area in a pixel, and once a stained area is converted to color values, the information about the stained position is to be lost. Thus, it is no longer possible to alter color values assigned to any particular position in the matrix. In short, the two workspaces, the first and the second memories are aimed to simulate colored subpixels rather than the black and white subpixels such as 103 in FIG. 1, but because of the virtuality done with the limited amount of memory provided in the two workspaces, it is not possible to alpha-blend the color values of stained subpixels. Then, discussed from the following sections are how to represent transparent objects under these conditions.

How to construct virtual eight layers is set forth now.

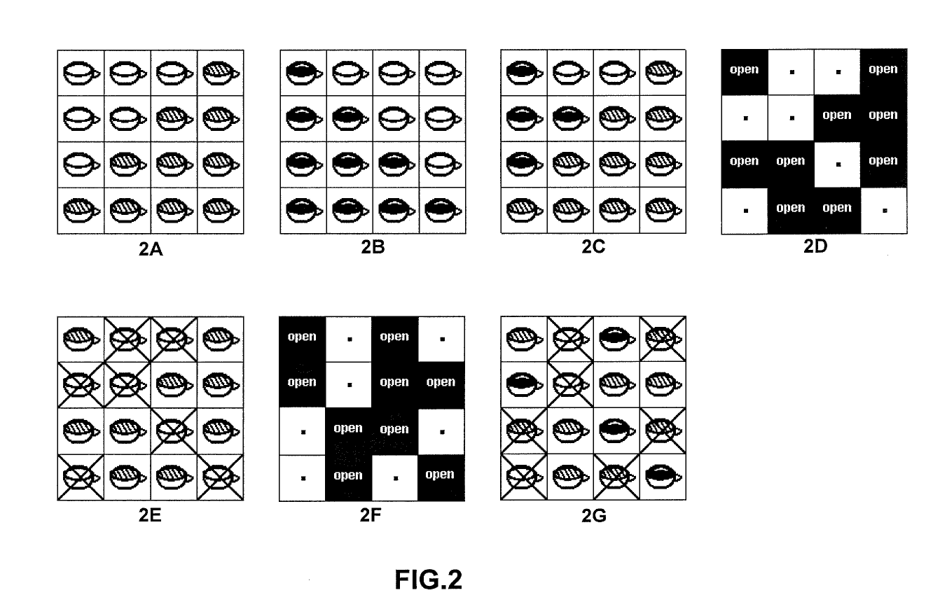

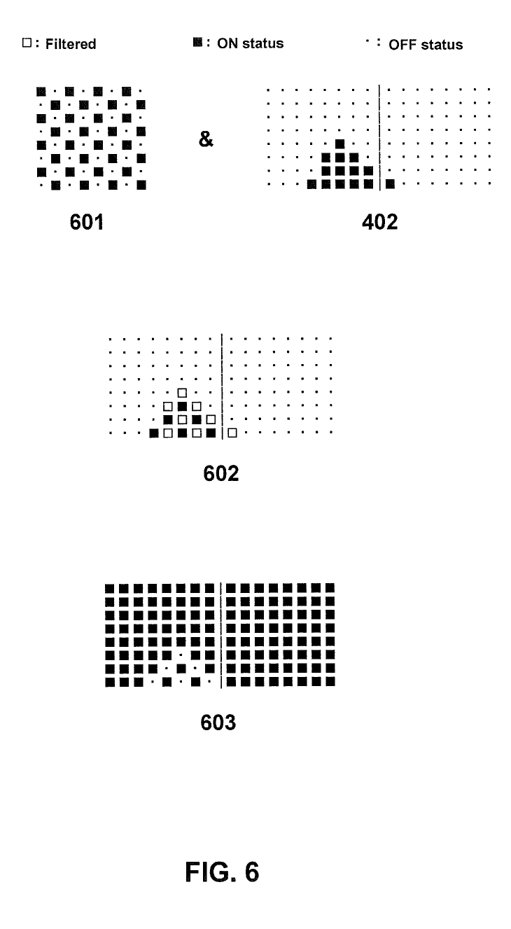

In the present invention, transparent representation is realized with bit masks. An additional AND operation is processed between a desired bit mask and the third memory which represents the coverage of the rendering object. As a result, those bits in OFF status positions in the bit mask are excluded from the third memory, gaining the visibilities of the background objects. A simple example of 50 percent filtering is shown in FIG. 6 where the third memory 402 is filtered through the 50 percent transparent filter 601, and the resulted third memory 602 is reflected in the first memory 603. In this process, the ON status positions of the bit mask function as the opened positions in 2D and 2F in FIG. 2. As for a plurality of transparent objects overlapping, the foreground object needs to be more visible than the background object, and this tendency should be maintained throughout the whole hierarchy in the overlaid areas. To represent the reduction of the backgrounds' visibilities, virtual eight layers are fabricated with bit masks. These bit masks overlap themselves fractionally in a predetermined sequence, forming a hierarchal structure through which the backgrounds' visibilities are reduced in accordance with the layers' accumulated volume. However, since the original silhouettes of rendering objects should be maintained in the filtered subpixels, it is necessary to design the bit masks from two viewpoints concomitantly. The first view reflects the above mentioned hierarchical structure which is aimed to simulate the reduction of the backgrounds' visibilities, whereas the second view represents the ON status positions' layouts in the two dimensional matrix.

To satisfy these requirements, the subpixels' matrix is defined as a set of “signal paths”. A signal path is an array of bit positions specified in the subpixels' matrix, on which the ON status positions for each layer shift sequentially in accordance with the layers' order. The ON status positions moving on the signal paths are expressed as running signals, and it is possible to describe the layers with signals in a manner such that each layer of bit mask is constructed as a snap shot of running signals at its corresponding moment. Basically, the length of signal path is equal to the number of layers, and a plurality of signal paths constitute the entire subpixels' matrix. Signal paths do not share any path point each other, and the subpixels' matrix can be divided into signal paths without any odd part. For example, eight signal paths of eight length are provided for 64 subpixels. The eight layers themselves are virtual existences just like the virtual 2D space of the subpixels. If an object's edge spills out from the virtual 2D space of subpixels, the edge is to be simply extended to another 2D space in the next pixel, but the virtual eight layers are not extensible. Therefore, the hierarchy for the eight layers should have a rotational structure. Even if eight transparent objects share an identical pixel, and the eight layers of bit mask are applied to it, the coverage of the respective objects is not necessarily 100 percent and there may be unstained area remaining in the pixel. In that case, the first layer functions as the layer beneath the last layer. By having the signals moved sequentially on the signal path of eight length, the layers' hierarchal structure becomes rotational in eight cycles. In exceptional cases, the length of some signal paths can be set to factors of eight. These exceptional signal paths do not violate the rotational structure.

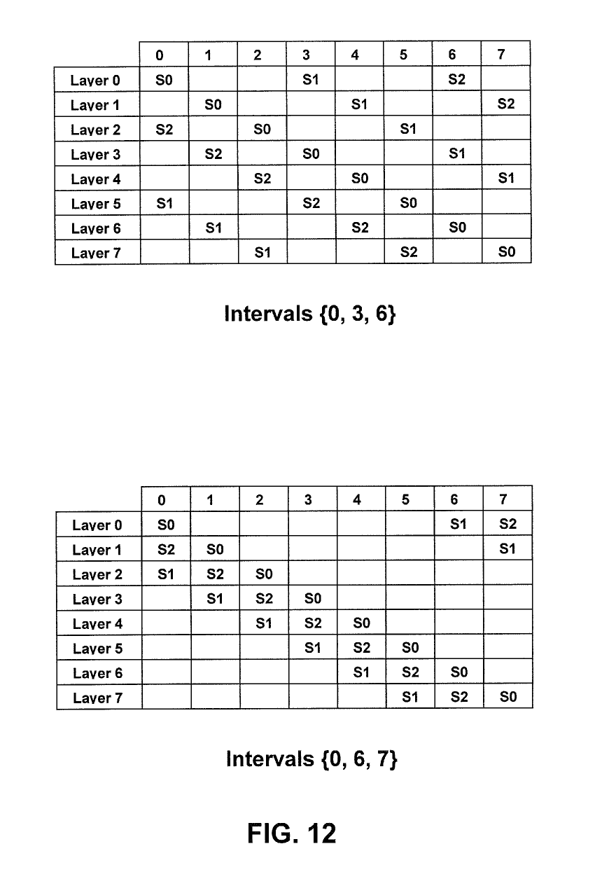

Definition of signal paths has another effect on the construction of the layers' hierarchy. When plural signals exist on a signal path, and their sequential movement is constant, the intervals amongst the signals are reflected on the layers' hierarchy. For example, when two signals exist on a signal path, and their interval is set to 1, their positions in the first layer are index 0 and index 1 along the path points' order, whereas the positions in the second layer are index 1 and index 2, and the last layer has them in index 7 and index 0. These signals' positions indicate that, as for the bit positions belonging to the signal path, each layer overlaps in one bit position with either of the two layers adjacent to itself in the rotational hierarchy. FIG. 12 shows examples of the hierarchies in two signal paths. In the two tables in FIG. 12, the passage of signals are lined diagonally in the same direction from the top left to the bottom right, which indicates that the signals proceed along the path points one by one constantly. When the two tables are rotated 90 degrees counterclockwise and mirrored horizontally, the layout of the signals' positions coincides with that of the original tables. Thus, it is possible to design the layers' hierarchy with the intervals amongst signals in respective signal paths.

There are two types of signal paths. The one is for single signal, and the other is for plural signals. The eight layers are a prototype of 75 percent transparent filters whose opacity is 0.25, and when the number of the subpixels is 2^{N}, the number of ON bits in each layer becomes K 2^{N}/4. Since each signal path has eight path points, the number of signals becomes twice the number of signal paths. K/4 signals are assigned uniquely to K/4 signal paths, and 3K/4 signals are distributed uniformly to the rest of K/4 signal paths where three signals reside par a path. This proportion of signals' assignment indicates that the half of the subpixels are reserved for signal paths for single signal. Since only one signal runs on each path for single signal, single signals are put at the foremost all the time, and behind single signals is no signal in the resulted hierarchy. This means that with these path points for single signal, each layer becomes visible beneath any other layer in the hierarchy, and obstructs the background view at the same time.

The layouts of signal paths are determined in respect to the ON status positions' layouts in the two dimensional matrix. Basically, the ON status positions' layouts for each layer should not be biased in any particular direction. From an overall view, a biased sampling done through each individual pixel is not necessary to be a serious problem. But if plural filters exist, and their biased directions are different, the representation of transparent objects will be inaccurate. As an initial step to solve this problem, the subpixels' matrix are disassembled into the smaller units of 4×4 regions where the number of ON bits in each disassembled unit reflects the proportion of the ON bits in the entire matrix i.e. the one fourth. Every four ON bits are distributed to every 4×4 region via assignment of two signal paths including the one for single signal and the other for three signals. Consequently, the running scope of every four signals is confined within the 4×4 frame placed in its intended location.

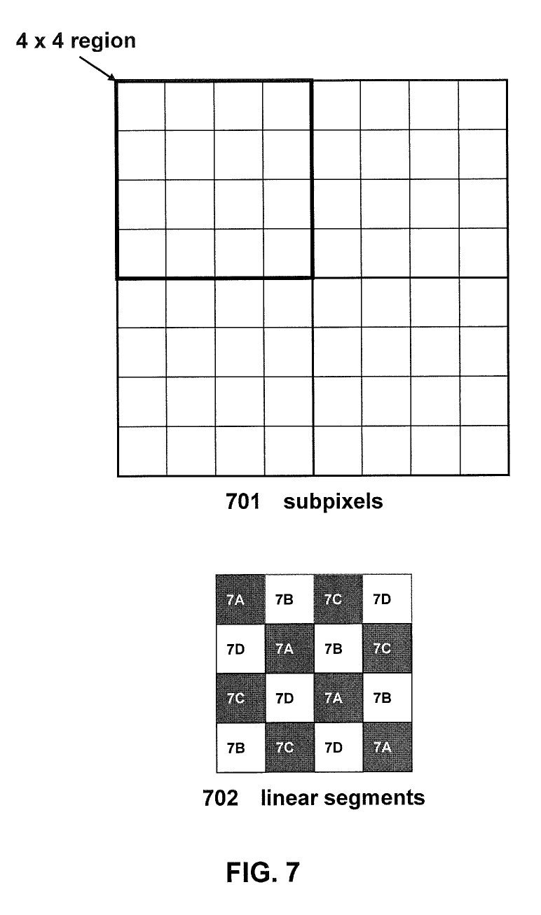

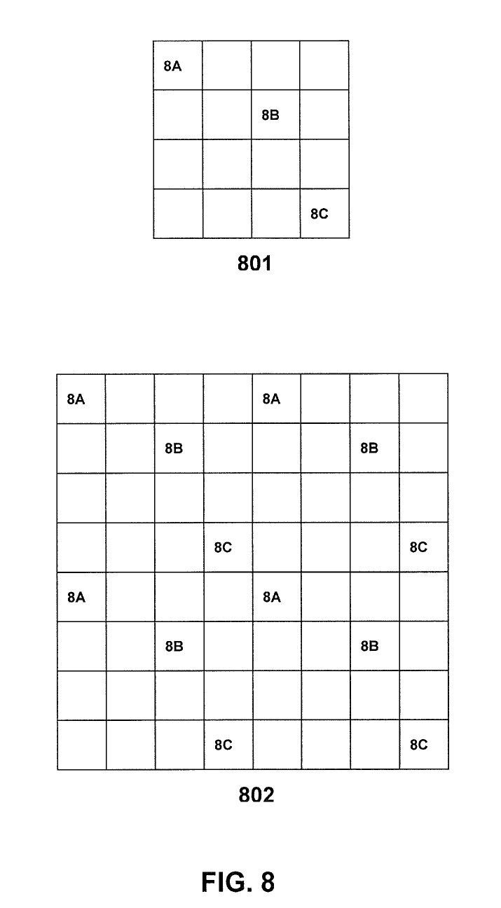

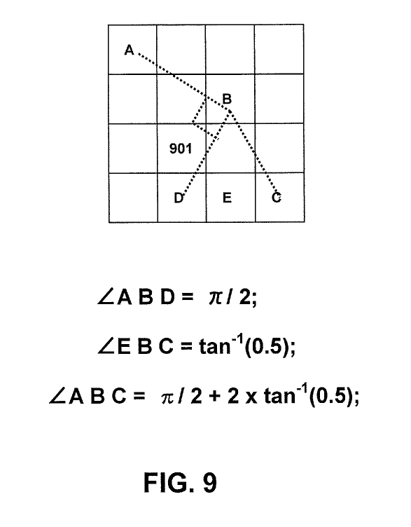

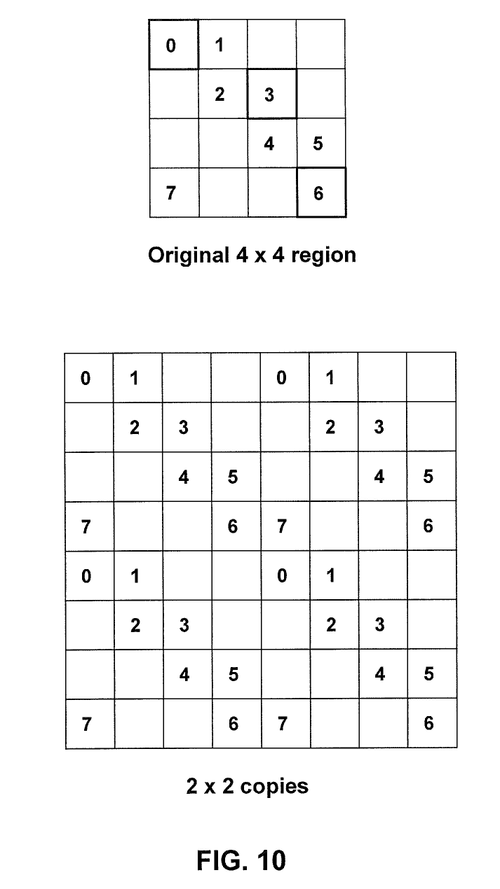

To achieve uniformity in the ON status positions' layouts, the ON status positions should not be concentrated at any particular coordinate position in the subpixels' matrix. More specifically, the four ON status positions in each 4×4 region should be assigned to respective coordinate positions in the 4×4 matrix. Discussed below is how to run the four signals confined within the 4×4 frame while satisfying the above requirement. The 4×4 region is further defined as a set of four linear segments. A linear segment consists of four subpixels lined diagonally within the rotational 4×4 matrix, and those belonging to the same 4×4 region do not overlap each other, sharing the same diagonal line slope as with 702 in FIG. 7. Signal paths are mapped along two adjacent linear segments respectively, and their path orders related to the linear segments are determined primarily with signal path for three signals. The three points 8A, 8B and 8C in 801 in FIG. 8 belong to two adjacent linear segments 7A and 7B in 702, and these three points are gapped each other in either coordinate in a manner such that the gaps of 8A to 8B, 8B to 8C and 8A to 8C are (2, 1), (1, 2) and (3, 3) respectively, where the gap of 8A to 8C indicates the sum of the first two gaps. If 8B is the peak of theta ∠8A-8B-8C, the theta is expressed with a radian value as R=π/2+2×tan⁻¹(0.5) as in FIG. 9. These three points constituting the radian R can be displayed in sixteen different layouts in the rotational 4×4 matrix. 802 in FIG. 8 shows 2×2 copies of the original 4×4 region 801. In 802, those sharing the same coordinate positions are every two points copied from the same original point, and every four copies of the same original form 5×5 square in the matrix. When the coordinate space in 802 is sampled with 4×4 frame at an arbitrary position, the three points included in the frame will be the copies of respective originals being gapped each other in either coordinate. To put this in another way, if three points included in two adjacent linear segments form the radian R=π/2+2×tan⁻¹(0.5) in a supposed coordinate space consisting of 2×2 copies of the original 4×4 region, the three points do not share any coordinate position in either X or Y direction. The gap between 8A and 8C is the sum of the previous two gaps, and the order of the previous two gaps can be swapped as (1, 2) to (2, 1). The three signals in this order also maintain the coordinate gaps amongst each other, hence the radian R referred in the above description can be in negative i.e. 2π−R. Back to 801 with the radian R's formation, the two end points, 8A and 8C share the same linear segment 7A, and the peak point 8B is uniquely assigned to the linear segment 7B. Considering the three points as the signals running on a signal path, if the path points in even indexes and odd indexes are separately assigned to the two linear segments, the signals for the two end points keep sharing either of the two linear segments at any moment, and the other signal for the peak point is to be uniquely positioned to the linear segment alternative to the one for the two end points. FIG. 10 shows an example of the path points' layout. If the three signals run on the path points constantly as {0, 3, 6}, {1, 4, 7}, {2, 5, 0}, . . . , the absolute radian R formed with the three signals is to be maintained. In this layout, each signal moves by one position horizontally when its positional index is incremented from even indexes to odd indexes, and by one position vertically in the opposite case. Tracing this sequence with the three points, when the two end points move by (1, 0), the peak point moves by (0, 1), and when the two end points move by (0, 1), the peak point moves by (1, 0). These movements result in alternating their coordinate gaps between (2, 1) to (1, 2) and (1, 2) to (2, 1), forming the radian R in positive and in negative. The additional one ON bit position for single signal is to be put at the mirrored peak point against the peak point, forming the mirrored radian R with the two end points, 8A and 8C. The starting position of the mirrored peak point is illustrated as 901 in FIG. 9. If the gaps of the three signals are (2, 1) to (1, 2), the gaps with the mirrored peak will be in their swapped order as (1, 2) to (2, 1), and since the determination of the mirrored peak point is based on the diagonal line between the two end points, the two peak points do not share coordinate positions in any direction. This relationship between the two end points and the two peak points is to be kept throughout any layer in the hierarchy whereby the four running signals always maintain coordinate gaps amongst each other, pointing to respective coordinate positions in the 4×4 matrix. As in the case of the peak point, the mirrored peak point is put on the linear segment adjacent to that for the two end points. When the two end points stay on 7A and the peak point is on 7B, the mirrored peak point should be put on 7D which is adjacent to 7A, and when the two end points stay on 7B and the peak point is on 7A, the mirrored peak point should be put on 7C which is adjacent to 7B. Thus, the mirrored peak point is to be put on the rest of the two linear segments, 7C and 7D, where 7D is for even indexes and 7C is for odd indexes. As the peak point walks along all the path points in 7A and 7B, the mirrored peak point for single signal is put on the corresponding positions in 7C and 7D whereby all the positions in the 4×4 region are traced with the four signals' passages in eight steps. The two linear segments, 7C and 7D, are reserved for signal path for single signal.

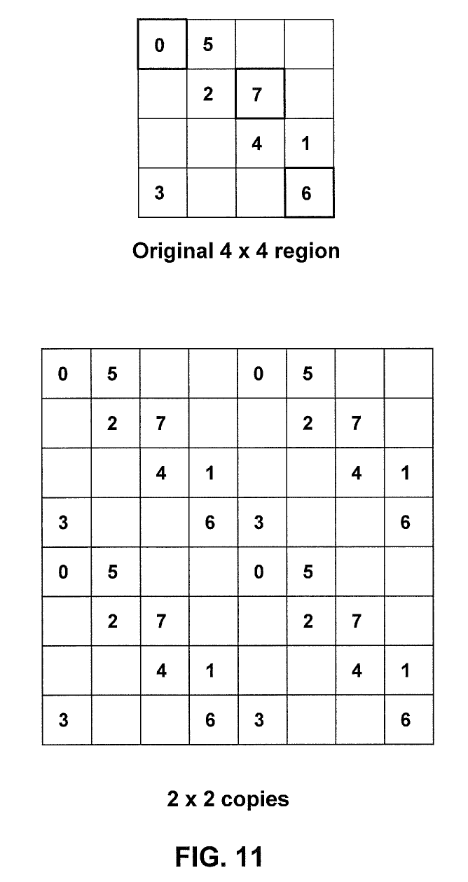

In the path points' layout shown in FIG. 10 each signal moves by (1, 0) when its index is incremented from even indexes to odd indexes, and by (0, 1) in the opposite case. As a result, the absolute radian R is maintained by alternating the order of the two coordinate gaps, (2, 1) and (1, 2). A similar process is possible with another path points' layout shown in FIG. 11. In this layout, each signal moves by (3, 2) when its index shifts to odd values, and by (2, 3) in the opposite case. The signals in this layout also maintain the absolute radian R. The three stating points in the first layout in FIG. 10 are {0, 3, 6}, and those in the second layout in FIG. 11 are {0, 6, 7}. As is mentioned, these intervals are reflected to the hierarchal structure within the signal path. The three signals are on the rotational paths, and to simplify the discussion, the intervals between two signals are expressed with a shorter length. For example, if the two signals start from the path point 0 and 6, the interval between the two signals is to be two length rather than six length. Conforming in this manner, the first layout whose starting points are {0, 3, 6} has 2 three-length intervals and 1 two-length interval, and the second layout with {0, 6, 7} has 1 two-length interval and 2 one-length intervals. Either of the two layouts has 2 odd-length intervals and 1 even-length interval because the signal at the peak position is uniquely placed in either of the two sets of indexes alternative to that of the two end points. If the intervals of the signals in the two layouts are added, the amount will include 2 one-length intervals, 2 two-length intervals and 2 three-length intervals. The number of the respective intervals is identical at 2, and in the hierarchy formed with the combination of the first and second layouts, each layer overlaps equally with any other layer from the following three layers and the previous three layers in the rotational hierarchy. This combination is adopted by having the two path points' layouts mapped to every two different 4×4 regions in the subpixels. The hierarchal structure formed by the two layouts is shown in FIG. 12. In the table 1201, all the path points are occupied with the passage of signals in the first three steps, which means, when the signal path is fully covered by three transparent silhouettes, the unstained bits remaining in its belonging 4×4 region are entirely those on the signal path for single signal. On the contrary, in case where the signal path is not covered at all with the first three silhouettes, the hierarchy for the area starts from the fourth layer as a variation of the original hierarchy.

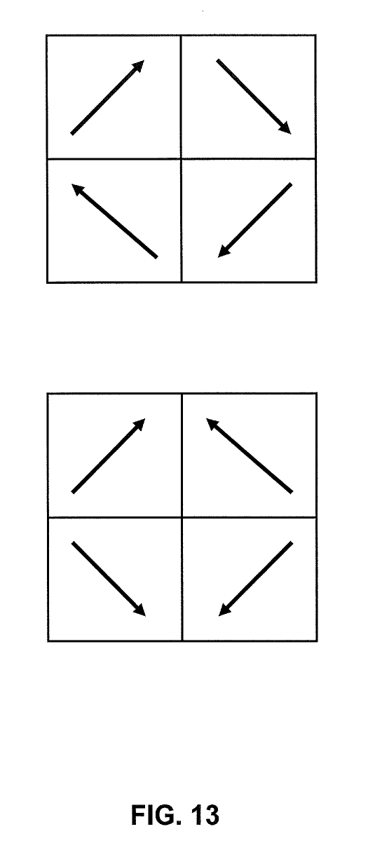

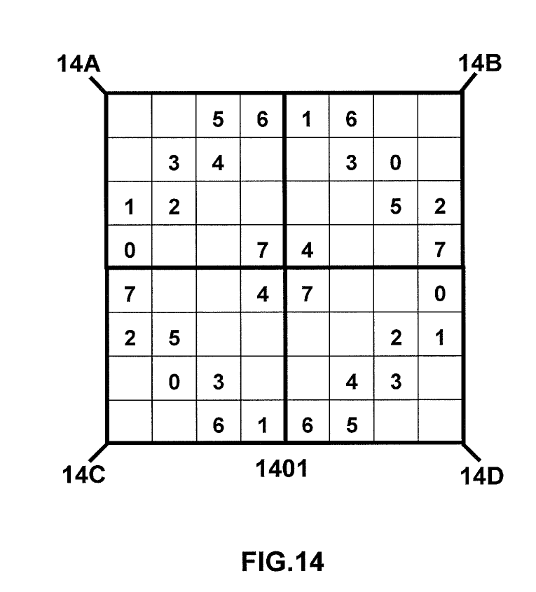

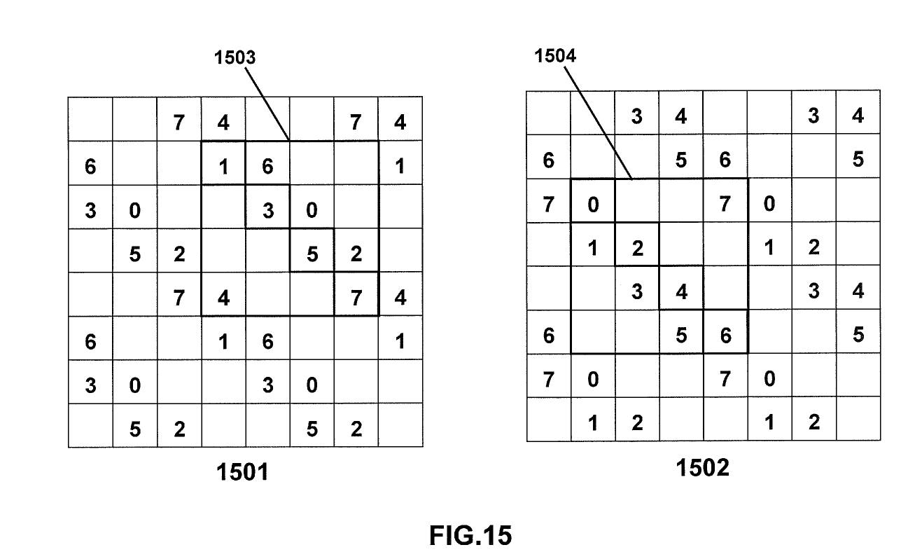

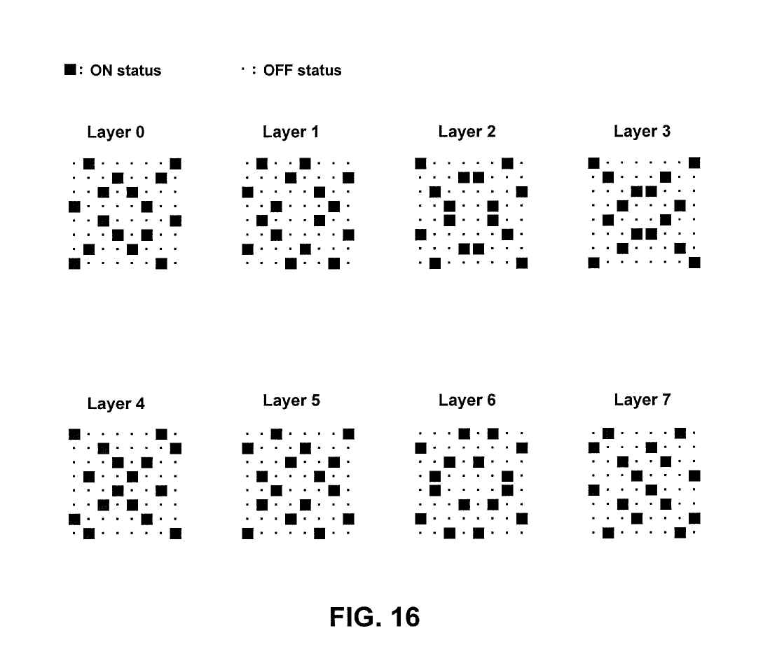

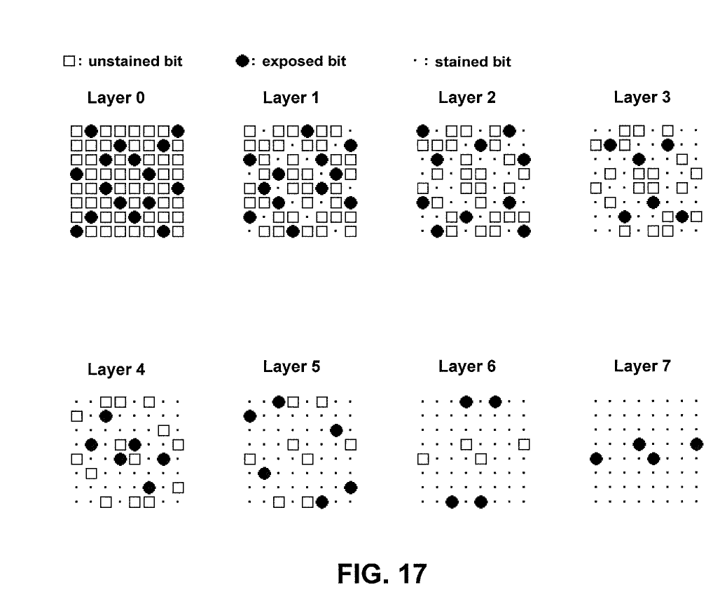

When the subpixels consist of four 4×4 regions, each path points' layout is to be shared by two 4×4 regions. However, these shared layouts should not be mapped to the subpixels' matrix as mere copies of the original layouts. As illustrated in FIG. 13, the proceeding directions of signal paths should be determined to counterbalance each other as being mirrored or rotated 180 degree. This determination affects the layout of the ON status positions exposed beneath those belonging to the other layers in the forefront. On the other hand, when several layers of bit mask are applied to a pixel, the unstained ON bits remaining for the subsequent rendering are mostly or entirely on the signal paths for single signal. Generally, the more the bit masks are applied, the more important the single signals' positions will be. Referred as path points' layout in this text substantially indicates the path order related to two linear segments, and as far as the indexes assigned to the two linear segments proceed in the same direction, it can be transformed and assigned to any possible two linear segments being adjacent in the rotational 4×4 matrix. Shown with 1401 in FIG. 14 is an example of the layout for signal paths for single signal. This layout is designed in a manner such that; in FIG. 15 are two sets of 2×2 copies of the path points' layouts for single signal in which the mirrored peak points are traced from the layout in FIG. 10 in the matrix 1501, and so done from the layout in FIG. 11 in the matrix 1502. Orderly lined four path points which read “0246” and “1357” are selected and sampled with 4×4 frames, 1504 and 1503 respectively. The proceeding direction of signal path, the top left to the bottom right is the same with that of the 4×4 region 14B in FIG. 14, and the 4×4 frame 1503 is the one to be assigned to 14B. If the matrix in FIG. 15 are mirrored horizontally, the proceeding direction coincide with that of the 4×4 region 14D, then the mirrored 1504 is assigned to 14D. The rest of the two 4×4 regions, 14A and 14 C, will be the 180 degree rotated structure of 14 B and 14 D. The path points' layouts for plural signals can be found by placing the two 4×4 frames, 1503 and 1504, to those 2×2 copies of the original 4×4 regions in FIG. 10 and FIG. 11. The resulted eight layers are in FIG. 16. If each layer in the illustrations in FIG. 16 is scanned along either X or Y axis, every coordinate position includes two ON status positions, and the sixteen ON status positions are evenly distributed to the four 4×4 regions. Thus, the uniformity in the frequency of ON status positions is embodied to a certain extent in each layer. When those layers in FIG. 16 are accumulated, the exposed bits of the last layer shift and reduce in accordance with their accumulated volume as in FIG. 17. These layouts are introduced for the best mode, but it is possible to design the eight layers in different manners. Or, since the layers' hierarchy is rotational, the first layer is not necessary to be the “Layer 0” in FIG. 16.

How to construct filter sets is set forth now.

The transparent levels of intended objects are selective via determination of the number of the layers to be applied, and by having consecutive layers combined in desired volumes, the filter sets for different levels of transparency are provided. Introduced in this section are three examples of filter sets that include 75 percent, 50 percent and 25 percent transparent filters. Each set consists of its members of filters corresponding to the respective layers, and these filters are selected for intended pixels along the layers' order so that the backgrounds' visibilities are reduced in a desired manner. The filter sets are trimmed by partitioning two signal paths, and in this respect, the filters are more or less “handmade”. Another purpose implied in this section is to reveal the idea and the effect as well as the difficulty in partitioning signal paths.

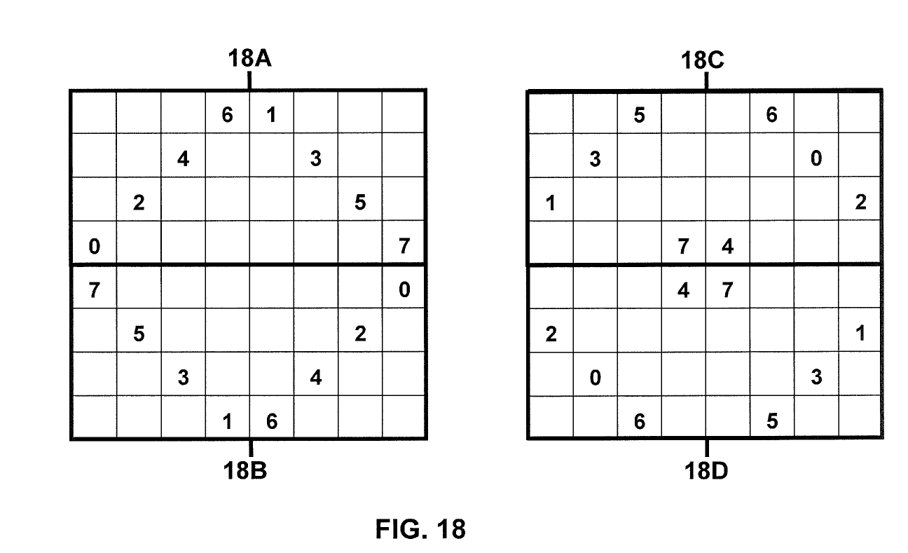

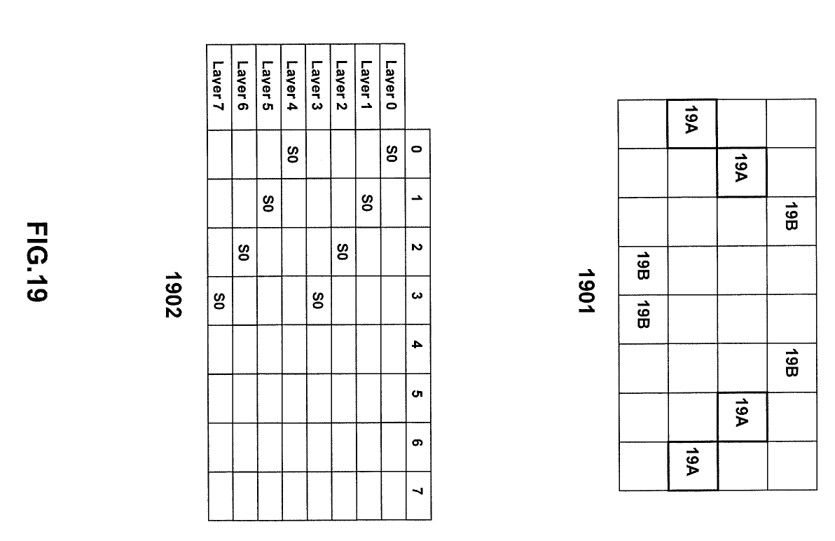

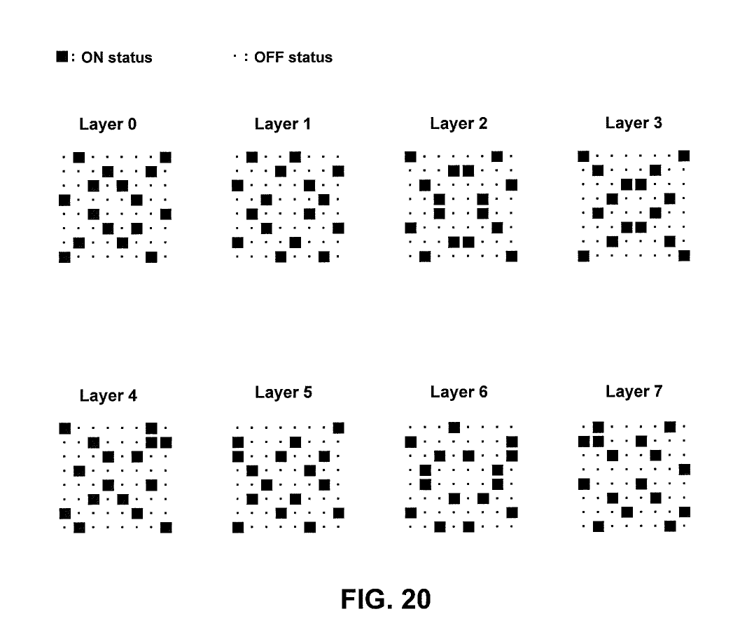

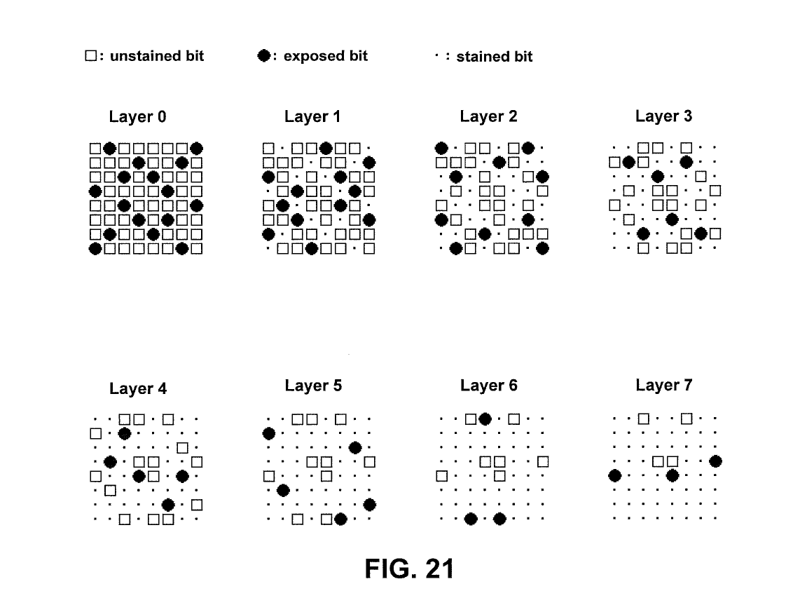

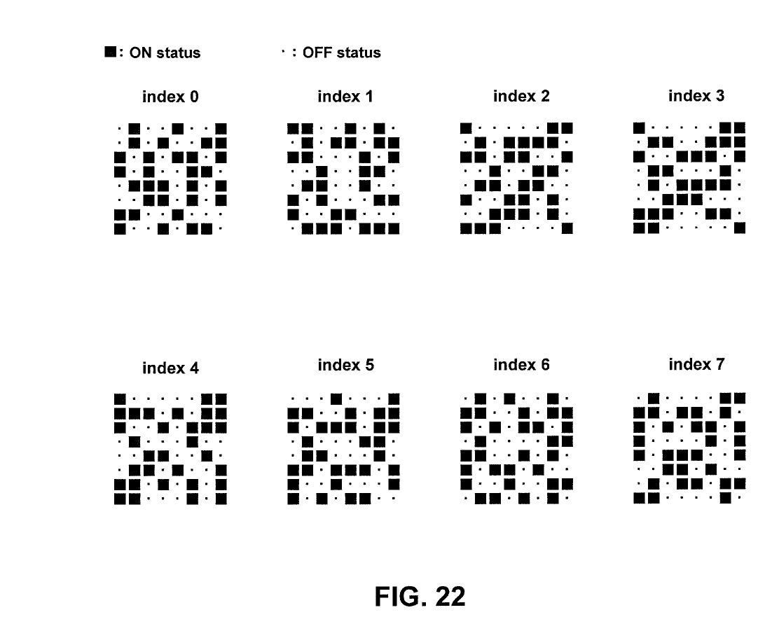

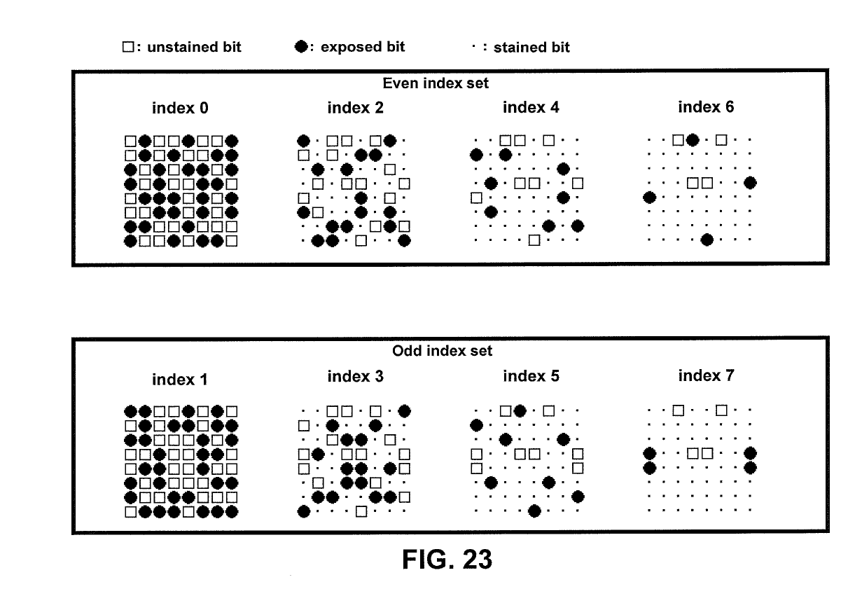

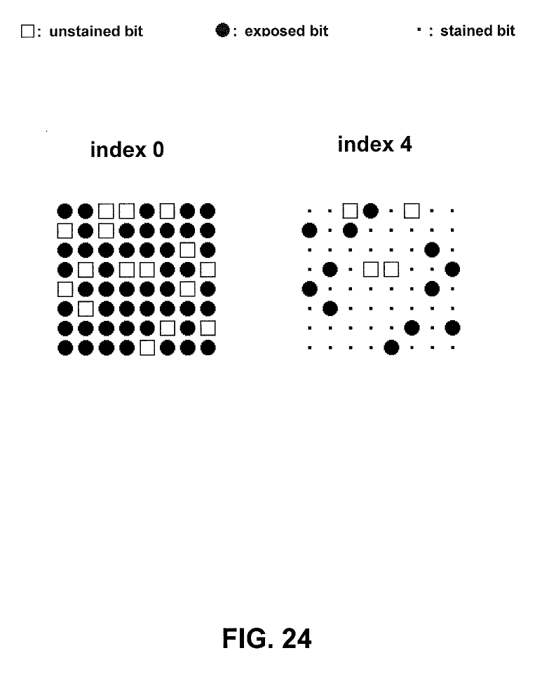

In the process to assemble the filter sets, it might be preferable to alter the original eight layers, and the signal paths for single signal are partly reserved for such cases. Since the hierarchal structure is formed with the signal paths for plural signals, the path points for the plural signals should remain untouched. The signal path for single signal in fact is an indistinct definition because no intervals in signals exist in the path. In other words, it is possible to comprehend the signal paths for single signal in various ways in the subpixels' matrix. The signal paths in FIG. 14 are redefined as in FIG. 18 where each path is mapped over two different 4×4 regions. The two paths, 18A and 18B, are reserved as fixed paths, and the rest of the two paths, 18C and 18D are defined as editable path. Basically, the additional works to be done on the editable paths are to make partitions on the paths. For example, when a single path for single signal is divided into two four-length paths for single signal, it results in adding one ON bit to each layer. In the examples for the best mode, the editable path 18C is divided into two signal paths of four length as 1901 in FIG. 19, and the one from the resulted paths is defined as the signal path for no signal, sparing its four path points in 19B as a signal free area never stained in the transparent representation. In the physical world, no matter how many translucent films are overlaid, the background view will not disappear. The signal free area in a sense simulates this nature, and is fit to the examples to be introduced in this section. The other partitioned path becomes rotational in four cycles as with 1902 in FIG. 19 thereby the layers' rotational structure is maintained. Although this alteration on the editable path 18C violates the uniformity of ON status positions' layouts in the original layers, the resulted eight layers are defined as a filter set for 75 percent transparency shown in FIG. 20. The first four layers are unchanged, and the last four layers' uniformities are disturbed in part. The flow for the exposed bits is also changed as in FIG. 21. The 50 percent transparent filters are assembled with the altered eight layers. Each filter is made of every two consecutive layers, but since these two layers overlap each other in 4 bits, the resulted bit masks will have 28 ON bits respectively, rather than the required 64×0.5=32 ON bits. To complete this filter set, additional four ON bits need to be prepared for each filter. As is mentioned, dividing a signal path into two pieces results in adding one ON bit to each layer, and inevitably, adding two ON bits to each 50 percent transparent filter consisting of two layers. Hence, two additional partitions are necessary to add the required four ON bits. The editable path 19A in FIG. 19 is further partitioned to add two ON bits on its belonging two 4×4 regions, and 18D in FIG. 18 is partitioned to add the rest of the two ON bits. The resulted bit masks are shown in FIG. 22. Since 50 percent filters consume every two layers, even index set and odd index set are produced. The exposed ON bits in the respective sets reduce as in FIG. 23. The 25 percent transparent filters are assembled by simply combining every two 50 percent transparent filters. Theoretically, the transmissivity of the paired 50 percent transparent filters becomes 0.5×0.5=0.25, and this equation is effective to construct the filter set as well. Each 25 percent transparent filter consumes four layers, and when the first filter and the fifth filter are applied, the exposed bits reduce as in FIG. 24.

The produced filter sets can be not perfect examples. For instance, the layouts of the ON bit positions in FIG. 22 are diagonally biased where the ON bits are concentrated along the top right to the bottom left line. The occurrence of this bias is due to the layers' structure formed with the combination of the two different hierarchies in FIG. 12. The 50 percent transparent filters are composed of two layers respectively, and their layouts are influenced from the overlapping ON status positions in every two consecutive layers. As is seen in FIG. 22, the strength of the bias differs amongst the bit masks, and a possible remedy to this problem is to select different starting layer with respect to the frequency of use of respective layers. The layouts in FIG. 22 themselves are influential in rendering the foremost silhouette(s) that include those spilled out from the silhouettes in the forefront. However, since the remedy is not the perfect solution, the discussion continues with the introduced examples left unchanged. Another bias is apparent in FIG. 23. The exposed bits' layouts in index 2 and index 3 are biased in a downward direction roughly by one subpixel line. This bias itself can be removed by comprehending editable path 18C and 18D in FIG. 18 in a different manner, but if that is the case, the layouts in FIG. 22 will be disturbed in part. The fundamental solution to this bias as well as to the violated uniformity in the 75 percent transparent filter set is to abandon the signal free area, and the signal free area is spared in quest of the reality in simulating the reduction of transmissivity. Then, traced in the following parts are how the introduced partitions effect on the flow of exposed bits' reduction, which include the partition on 18C to reserve the signal free area, the partition on 19A to add two ON bits to the 50 percent transparent filters, and the partition on 18D to provide another two ON bits for the filters. In this section, the numbers of exposed bits at every accumulated volume are aligned in the left to the right order, and these values are joined with “+”. For example, the numbers of the exposed bits of the original eight layers are expressed as:

16+12+10+6+6+6+4+4=64

To spare four bits for the signal free area, the editable path 18C is divided into two pieces. This alteration results in having one signal in the last four layers hidden by the same signals' passages in the above layers as with 1902 in FIG. 19. The original flow is altered as:

16+12+10+6+5+5+3+3=60

Each filter hereafter is expressed with the number of layers being comprised. The 75 percent transparent filter which consists of single layer becomes L1 filter, and so does the 50 percent transparent filter become L2 filter. If every two L1 filters are simply combined to construct the L2 filters, the flow becomes:

28+16+10+6=60

For L2 filters, two signals run on the signal paths for single signal, and when the four-length path 19A in FIG. 19 is further partitioned, the resulted paths are fully occupied with signals because either of the resulted paths has only two path points. This alteration is expressed below with bit arrays indicating the signals' positions. For example, since the signal moves by two positions in every step in the even index set, the signals in 19A originally start from “1100” to “0011”, and if these path points are filled with signals, the result becomes “1111”. As to the values indicated beside the bit arrays, the number of additionally exposed bits is expressed with “+”, and the number of previously exposed bits hidden by those given to the above layers is expressed with “˜”.

1100—>1111+2
0011—>1111−2
1100—>1111+0
0011—>1111+0
The resulted flow is:

30+14+10+6=60

When the additional two ON bits are provided by dividing another editable path 18D into 2 four-length paths, the signals in the editable path 18D become:
11000000—>11001100+2
00110000—>00110011+2
00001100—>11001100−2
00000011—>00110011−2
The resulted flow precisely represents the 50 percent transparent filtering as:

32+16+8+4=60

When every two L2 filters are combined to construct L4 filters, the flow becomes:

48+12=60

Since the opacity of L4 filter is 64×0.75=48, and the opacity for the second mask becomes (64-48)×0.75=12, no additional work is necessary for L4 filters.

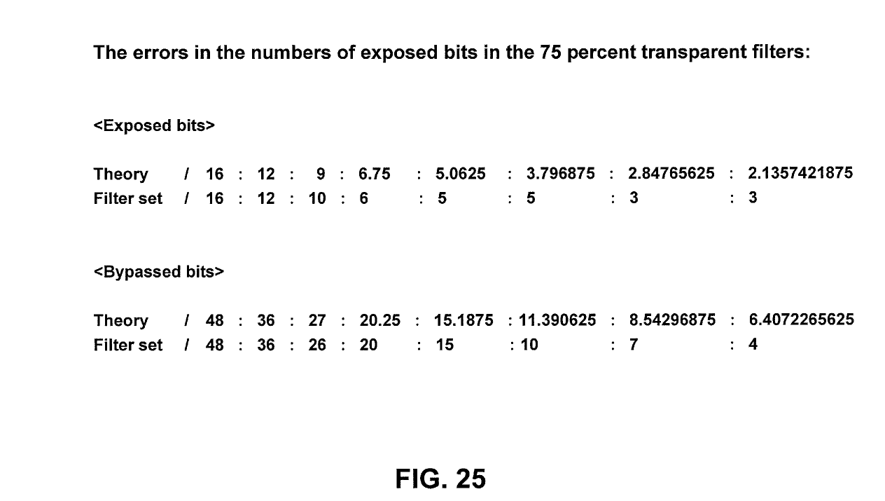

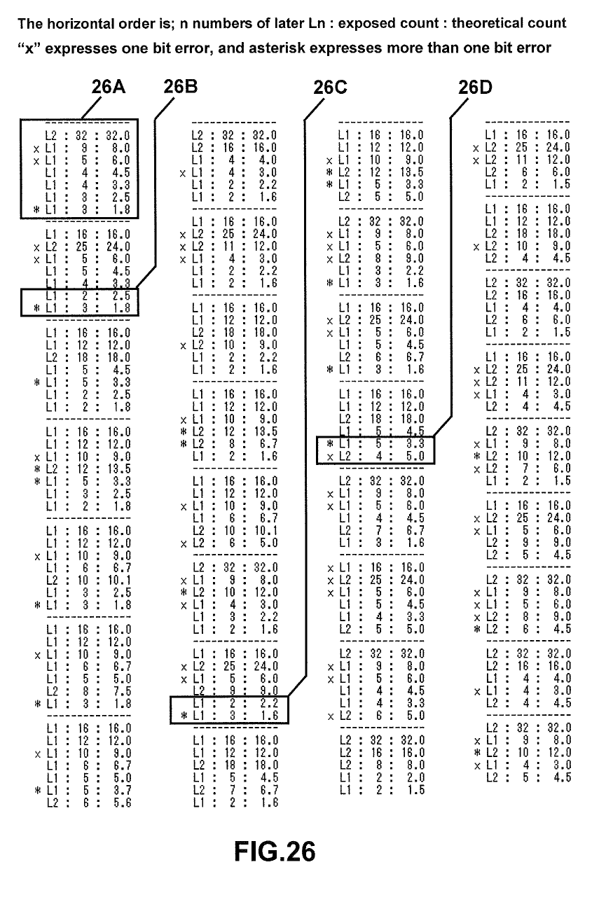

There are two elements that bring about inaccurate results in the expressions of transmissivity. First, the reduction of exposed bits is not precisely embodied with the L1 filters as in FIG. 25. Second, the additional alterations on the editable paths done for the L2 filters are not reflected on the L1 filters. When the transparent ratio with the L1 filter is T, the combination of two consecutive L1 filters transmit T×T. From another angle, the L1 filter's transparency should be the square root of the L2 filter's one. This logic effects in assembling filter sets as in the case between the 50 percent transparent filter set and the 25 percent transparent filter set. When the partitions for the L2 filters are applied to the L1 filters, the resulted filters represent approx. 71 percent transparency comprising 18 ON status positions where 0.71 is about the square root of 0.5. In short, as for the editable path 18D and 19A, two different hierarchies are produced via the above procedures. When filters in the two different hierarchies are applied to an identical pixel, the exposed bits are reduced as in FIG. 26. The L4 filters are not included in the examples because the filters are made of the L2 filters sharing the same hierarchy. Each flow in FIG. 26 proceeds in a downward direction, and the total volume of accumulated layers in each flow becomes eight layers. On every line, those values including the combined layers' count, exposed bits' count and theoretical exposed bits' count are horizontally aligned, and when an exposed bits' count is gapped over one bit from corresponding theoretical value, its position is marked with “x” or asterisk. As the flows in FIG. 26 indicate, the most of those error gapped over one bit's count are compensated with the subsequent filtering. For example, the second filtering in the flow 26A results in 9 exposed bits which is one bit plus from its theoretical value, and the subsequent filtering absorbs the gap with 5 exposed bits which is one bit minus from the theory. Considering those errors in prior art caused by the reiterated computing of: pixel value=Ci×forecolor+(1−Ci)×backcolor, which is often processed with the rounded integer values for color components such as RGB, the margin of errors in approx. 1/64 should be in acceptable levels. Yet, more serious errors are found in two parts of 26B and 26C. In either of the two parts, the L1 filtering is processed twice, but the flow of the exposed bits' counts are reversed as increasing from 2 to 3. Another reversed flow is detected in 26D where the exposed bits' count is decreasing from 5 to 4 while the theoretical values are increasing from 3.3 to 5.0. These reversed flows are due to the two different hierarchies. The 71 percent filtering is not adopted for the best mode because it violates the ON status positions' layout, and the introduced filters are constructed in a balance between two tradeoff issues. On one hand, the ON status positions' layout is in part sacrificed to pursue the realistic representation of transmissivity, and on the other hand, the layers' hierarchal structure is in part disturbed to keep the filters' sensitivity reflecting precise objects' silhouettes. However, the reversed flow in the exposed bits' reduction is not avoidable in the present invention because it occurs due to the ON status positions' layouts as well. For example, if two objects cover approx. 60 percent of the upper part in a pixel, and if the objects' silhouettes are sampled via exposed bits in index 6 and index 7 in FIG. 21, the silhouette with the index 6 is sampled with one bit while the other silhouette with index 7 is sampled with three bits, which means, the last object becomes more visible than the other object in the forefront. As in the case of the biased layouts in FIG. 22, this particular problem may be calmed with the alteration of the layers' order. Still, these considerable errors are found mostly in 75 percent transparent filtering in the last few layers of the eight layers' accumulation, and as for the errors caused through the layers' hierarchy, the occurrences of the reversed flow in the exposed bits' reduction are not so frequent as indicated in FIG. 26. Then discussed from the following sections is how to maintain the layers' order, preventing further disturbance on the flow of the exposed bits' reduction.

How to select the filters to be applied is set forth now.

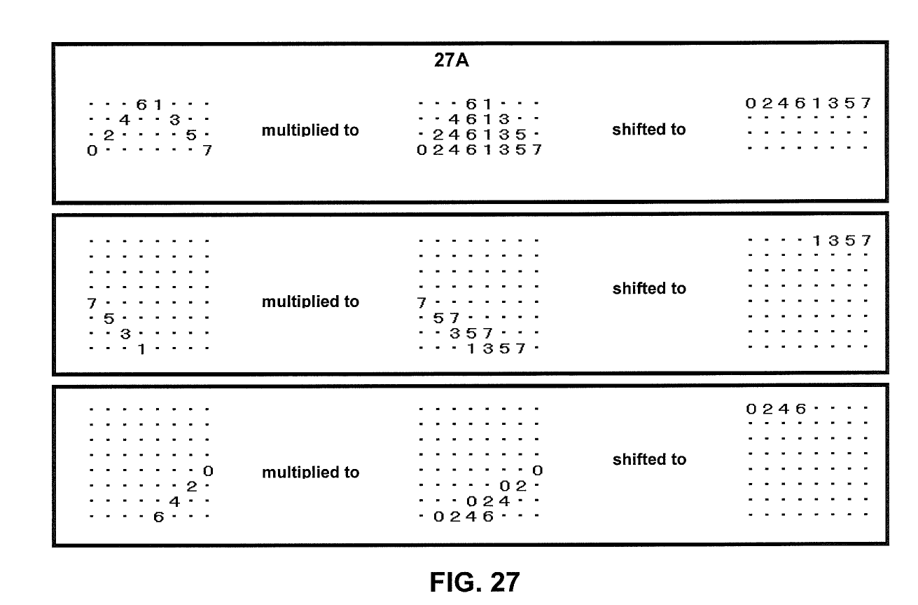

The transparent filters are selected in two steps. The first step is to detect those layers yet to be applied to the intended pixel, and the second step is to select the appropriate layers from the applicable layers. In the first step to detect the yet-to-be-applied layers, those bits on the path points for single signal are examined. Since each bit on the path uniquely belongs to a corresponding layer, its bit status is a key to identify the layer's availability. The two fixed paths for single signal, 18A and 18B in FIG. 18, form “monitoring circuit” which is exhibited as a 45 degree rotated square in the subpixels' matrix. If two bits that belong to an identical layer on the monitoring circuit remain in ON status, it is probable that the layer is not yet applied, or the applied area is less than 50 percent of the subpixels. Those bits on the monitoring circuit are assembled into an eight-bit array for eight layers, and the applicable layers are searched with the resulted eight bits. Since the monitoring circuit consists of linear segments, the eight bits can be deprived with those multipliers that include 0x01010101, 0x41041, 0x40100401 . . . etc. and their corresponding offset values to travel the multiplied bit blocks. The specific operations depend on the bit layout for the subpixels, but the process to multiply the linear segments to form successive bit segments in desired orders, and to shift the resulted bit segments to form the eight-bit array is illustrated in FIG. 27. These operations themselves are common skills in computer programming. For the first half of the 64 subpixels shown with 27A, the multiplier is to be 0x01010101, and it is the same as in 32 subpixels' environment. This is the reason for the introduced requirement for the 32 subpixels' matrix. Through the processes in FIG. 27, a pair of different eight-bit arrays is acquired. The two bit arrays are AND operated to find paired bits both remaining in ON status, and when the resulted bits indicate that the applicable layers are insufficient for the expected filtering, the two bit arrays are OR operated to indicate the applicable layers. Each bit position in the eight bits functions as the ID bit for corresponding later, and those filters composed of plural layers are identified with plural ID bits. The eight-bit array is hereafter called as “ID holder” or “applicable ID holder”, and its content is expressed as a bit array with “0” and “1”. When the first bit for the subpixels points to the top right corner in the matrix, and the ID holder is attained via the operations in FIG. 27, the ID bit for the “layer 1” for instance is to be “00001000”. If the layers' order is altered, the ID bit for “layer 1” is to be defined at a different position in the eight-bit array. To gain the visibility of ID's positions, the ID bits hereafter are temporary expressed in the left to the right order. For example, the ID bit for the first layer is to be “10000000”, and that for the last layer is to be “00000001”.

Preferably, the applicable ID holder is stored in some part of the memory, and the operations in FIG. 27 are not processed on every occasion as a filter is applied. All bits in the stored ID holder are initialized to be ON status, and as a bit filtering is processed, the ID bits for the applied layers are inverted to OFF status. In case that the applicable layers informed with the ID holder are insufficient for the desired filtering, the ID holder is to be reassembled in the above introduced manner. This procedure is not only to fasten the rendering speed, but also to improve the accuracy to maintain the applying layers' order. As for each L2 filter comprising two consecutive layers, four path points in the monitoring circuit are examined. But for the L1 filters, the applicable filters are identified with every two path points. The order of the first eight layers to be applied is guaranteed with the stored ID holder.

For the second step to select the appropriate layers, look-up tables are provided for the respective filter sets. The look-up tables function to translate the applicable ID holder into the next filter to be applied. For example, if the applicable ID holder indicates that only the third and the forth layers are already applied to the intended pixel, the next layer should be the fifth layer rather than the first layer. Since the eight layers form a rotational structure, the desired filtering is expectable with the layer subsequent to the end of the applied layers. In case where partitions exist in the applicable layers' order, the next layer should be selected from the smallest partition to remove the partitions in as fewer steps as possible. Once the applicable layers are aligned without partitions, the following filtering is to be done orderly as in the previous example. Thus, there are priorities in selecting the next layer to be applied, and the look-up tables should represent the priorities as follows:

(1) when partitions exist in applicable layers' order where the layers' order is rotational, select a layer(s) designated with ID bit(s) in the smallest partition;
(2) when a plurality of applicable layers are aligned consecutively where the layers' order is rotational, select a layer(s) designated with ID bit(s) in the first part of the alignment;
(3) select a layer(s) in accordance with applicable layers' order.

When those bits on the monitoring circuit are irregularly consumed, the applicable ID holder deprived from the monitoring circuit can be partitioned in various layouts. Therefore, the look-up table for the eight layers should be capable of 256 entries to respond to any possible situation. Since each layer overlaps equally with any other layer from the following three layers and the previous three layers, the first disturbance on the layers' order may possibly be absorbed, but the second one may not be. With detailed-designed look-up tables, the errors caused under various circumstances will be kept within the minimum possible range. Discussed below are preferable procedures to construct the look-up tables.

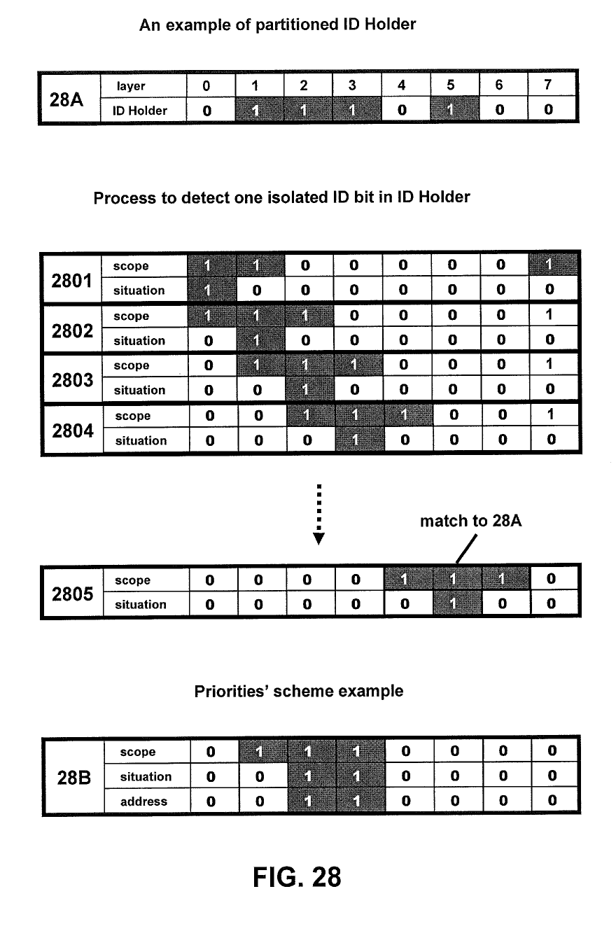

In the example of the ID holder 28A in FIG. 28, the ON status ID bit for layer “5” is isolated from the other ON status ID bits' alignment, and the next layer for 28A should be the layer “5” to let the following filtering be done orderly. To detect the isolated ID bit, every three consecutive ID bits in the ID holder are examined with two corresponding bit arrays indicating the search scope for the examination and the expected situation within the search scope. When the ID holder 28A is examined in a loop where the search scope and the expected situation are altered orderly as 2801, 2802, 2803, . . . the isolated ID bit is to be detected at 2805. The look-up table is constructed via these sets of eight-bit arrays called “priorities' schemes”. A priorities' scheme consists of 3 eight-bit arrays in ID holder's format as 28B, which designate search scope, expected situation within the search scope, and the ID bit of the preferable layer(s) to be applied. The priorities' schemes are applied in a manner such that: first, the filter objects are inserted into their IDs' address in the table; then in the loop from 1 to 255, every incremented index is examined as a possible variation of the applicable ID holder. The examined index is AND operated with the search scope, compared to the expected situation, and if satisfied, the filter object being inserted in the preferable layer's address is to be shared and put at the examined index. More specifically in the case of the ID holder 28A, the applicable ID holder reads “01110100”. Three consecutive ID bits in the ID holder become the subject to be examined via AND operation with the search scope “00001110”, and its result coincides with the expected situation “00000100”. Then the layer “5” stored at “00000100” is to be inserted to the address designated with “01110100”. Consequently, when the next layer is searched with the applicable ID holder “01110100”, the look-up table returns the layer “5”. These examinations are processed in another loop nested under the above loop, where the 3 eight-bit arrays for the examination are changed in accordance with the priorities' order. Basically, each priority's scheme has eight variations corresponding to every bit position in the eight bits, and the variations of the respective priority's schemes are joined to form the whole order, which means that when no variation of the first priority is satisfied, those for the second priority become effective.

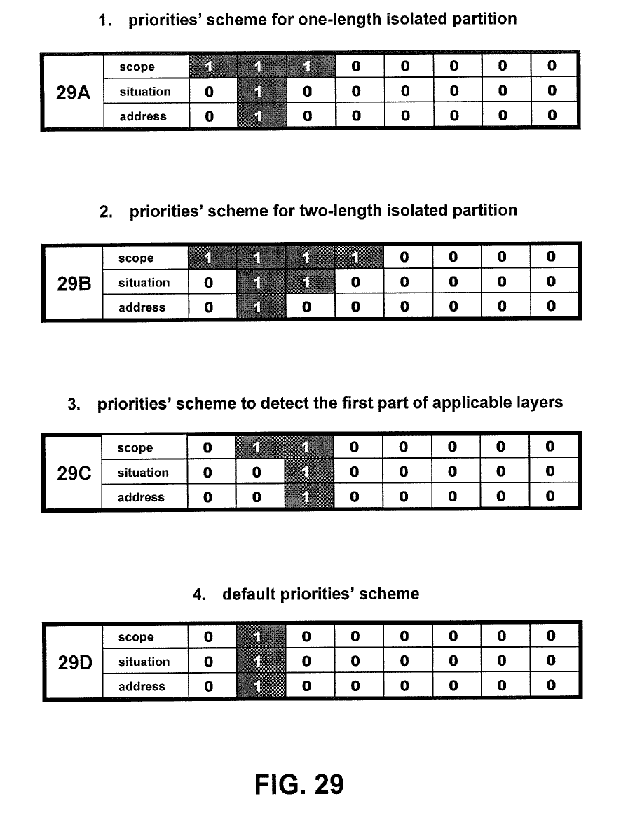

FIG. 29 shows four basic patterns of the priorities' schemes for L1 filters. The priorities' scheme 29D is the default scheme representing the above (3) in which the three members are identical. The priorities' scheme 29C functions to maintain the layers' order in the rotational hierarchy as indicated with the above (2). This priorities' scheme effects when the first layer remains applicable as such in the case of “10111111”. Therefore, the variation preferably starts with the one for the third layer. When this priorities' scheme becomes effective, partitions are already examined, and this priorities' scheme is aimed to detect the first part of an applicable ID bits' alignment. Illustrated at 28B is a variation of this priorities' scheme for L2 filtering. The priorities' scheme 29A and 29B are those for partitioned ID holders indicated with the above (1). The priorities' scheme 29A, 29B and 29D have 8 variations corresponding to respective positions in the eight bits, and the priorities' scheme 29C has 6 variations. Three consecutive IDs' partition is not included in FIG. 29 because if three IDs' partition is the smallest partition, the other partition should also have three IDs, and it can be removed with other priorities' schemes in three steps. For example, when two three IDs' partitions {7, 0, 1} and {3, 4, 5} exist as “11011101”, the look-up table returns the layers designated with “00010000”, “00001000” and “00000100” orderly to remove one of the three IDs' partitions that results in “11000001”. The look-up table is designed to return the first three layers as follows:

For the ID holder “11011101”, the look-up table returns the layer designated with “00010000”. This layer is inserted to the address “11011101” through a variation of 29C.

| | |
|---|---|
| ID holder | 11011101 |
| scope | 00110000 |
| situation | 00010000 |
| address | 00010000 |

(2) The selected layer's ID “00010000” is inverted, and for the resulted ID holder “11001101”, the look-up table returns the layer designated with “00001000”. This layer is inserted to the address “11001101” through the priorities' scheme of a variation of 29B.

| | |
|---|---|
| ID holder | 11001101 |
| scope | 00011110 |
| situation | 00001100 |
| address | 00001000 |

(3) The selected layer's ID “00001000” is inverted, and for the resulted ID holder “11000101”, the look-up table returns the layer designated with “00000100”. This layer is inserted to the address “11000101” through the priorities' scheme of a variation of 29A.

| | |
|---|---|
| ID holder | 11000101 |
| scope | 00001110 |
| situation | 00000100 |
| address | 00000100 |

Once either of the three IDs' partition is broken, the subsequent layers' selections will concentrate entirely on the broken part, and the other three IDs' partition will be left unselected. Hence, one of the three IDs' partitions is removed with the minimum cost in three steps.

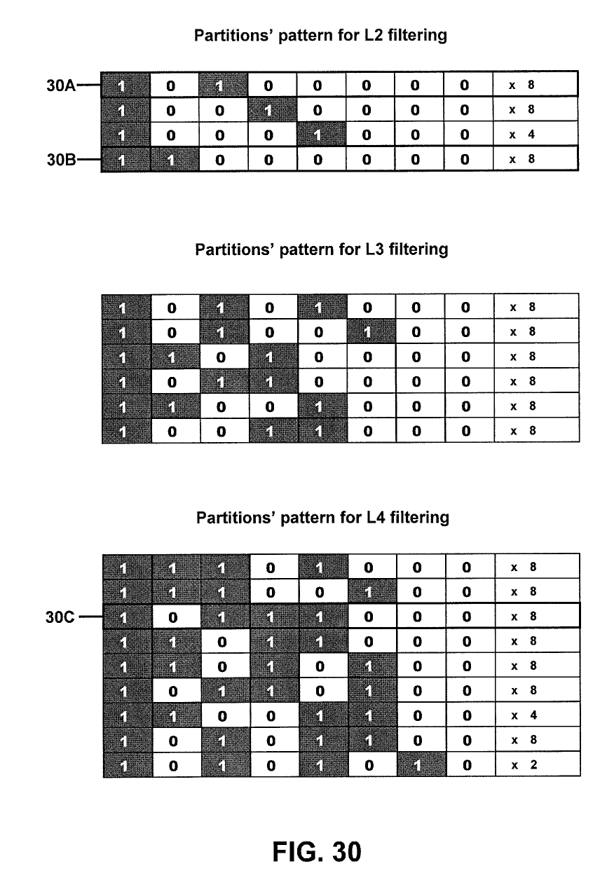

As for the filter sets consisting of combined layers, it is possible to provide the look-up tables in two ways, depending on the method to filter irregularly filtered pixels. For example, if the applicable layers remaining for the L2 filtering are only the third and the fifth layers, the pixel can be filtered by the L1 filters twice, or by a custom filter provided for the partitioned layers. For the former method, additional procedures to instruct the loop count are necessary. The structure of the look-up table is to be simple in this method, but the procedures to apply filters may not be. Therefore, the latter method is adopted for the best mode. The process to create the custom filters includes: providing the necessary partitioned patterns, combining plural filters in the higher transparent level(s) to construct the custom filters for the patterns, inserting the resulted filters to the look-up table in the patterns' address, and providing the priority's schemes for the pattern. The necessary patterns and the amount of their required variations are shown in FIG. 30. These patterns are selected from their shortest length variations to keep the search scopes for the patterns as compact as possible. For example, pattern 30C has the IDs' order as {0, 2, 3, 4}. This is a variation of {0, 1, 2, 6} where the first three IDs are consecutive. The search scope for {0, 2, 3, 4} is to be shorter than that of {0, 1, 2, 6}, and this is the reason to select the variation for pattern 30C. On the other hand, there are priorities amongst the patterns for two layers and the patterns for three layers. In the two sets of patterns, those having two consecutive layer IDs are put in the lower positions in the priorities' order. For example, the priority of pattern 30B is put lower than that of pattern 30A. To make the following discussion more understandable, it may effect to mention that these complexities occur basically in tracing the reiterated use of L1 filters i.e. the former method introduced.

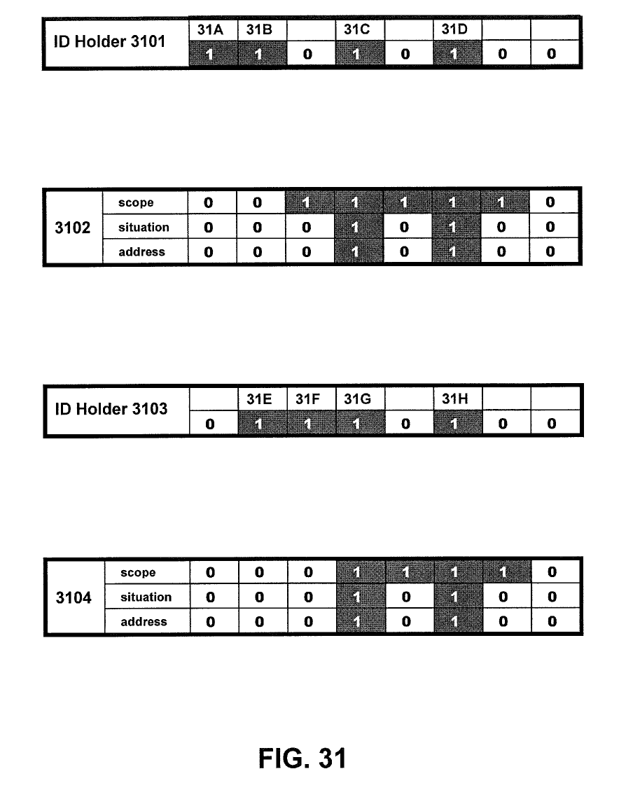

For the priority's schemes for partitioned patterns of plural layers, three variations of search scope are provided for respective patterns, which include search scope extended one ID bit from the intended pattern in both sides and the two search scopes extended one ID bit in either of the two sides. The first one is for isolated partitions, and the other two are for joined partitions. The isolated partitions are put in the higher priority in comparison to the joined partitions. In FIG. 31 shown are examples for the L2 filtering. To remove IDs' partitions in applicable ID holder 3101, the next two layers are expected to be 31C and 31D. Pattern 30A is the one to be detected, and its variation is referred in priority's scheme 3102. As is indicated in its search scope, the priority's schemes 3102 is for isolated partition. For another example 3103, the next two layers should be 31G and 31H. The pattern for the two layers is the same as in the previous example, 30A, but the search scope is different. Priority's scheme 3104 for the ID holder 3103 is for joined partition. If the priorities' order between isolated partitions and joined partitions is swapped, the next layers for the ID holder 3101 become unexpected two layers of 31B and 31C. On the other hand, if pattern 30B is put at higher position than that of pattern 30A, the next two layers for the ID holder 3101 will be inappropriate 31A and 31B. Again, if the ID holder 3101 is examined twice according to the priority's schemes for the L1 filtering in FIG. 29, the next layers will be precisely selected as 31C and 31D. Thus, the patterns' order, as well as the highest priority given to the isolated partitions effects to trace reiterated use of the L1 filters. Still, there is an exceptional pattern in FIG. 30. Since the pattern 30B itself is not a partition, only the priority's scheme for isolated partition is necessary for the pattern. Any possible partitions in ID holder can be removed with a single custom filter for plural layers other than the following fourteen exceptions. These exceptional partitions will not be removed with a single L2 filtering, and the bit arrays below indicate how the partitions remain after the L2 filtering.

2 variations of “10101010”
10101010—>00001010
01010101—>00000101
8 variations of “11011010”
11011010—>01011000
01101101—>00101100
10110110—>00010110
01011011—>00001011
10101101—>10000101
11010110—>11000010
01101011—>01100001
10110101—>10110000
4 variations of “11101110”
11101110—>11100010
01110111—>01110001
10111011—>10001011
11011101—>11000101

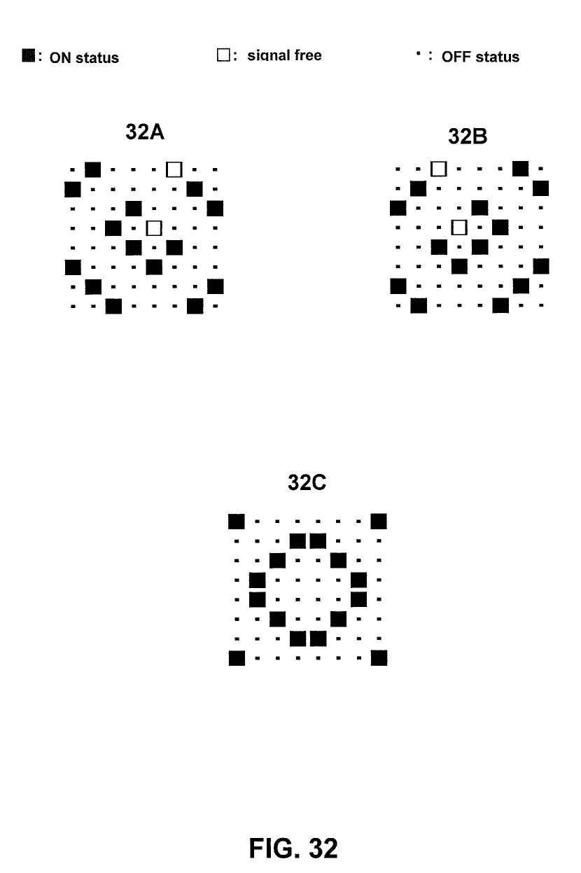

The priority's schemes for plural layers should comprise those for smaller number of layers. The priority's schemes for the L4 filters for instance should include not only those schemes for four layers, but also those for three layers, two layers and one layers. Then the next consideration should be given to the case where the applicable layers are insufficient for the desired filtering. To solve this problem, three default masks are provided. Even after all the bits on the monitoring circuit are consumed, unstained bits may remain in the intended pixel, and the default masks effect in such a case. The default masks are made of linear segments themselves. Each linear segment is assigned to the path points' order for even indexes or odd indexes of a signal path, and as signals run, the number of signals on a respective linear segment alternate between one signal and two signals along signal path for plural signals, and between one signal and no signal along signal path for single signal. The linear segments to constitute the default masks are selected with respect to these amounts of the signals. The two default masks, 32A and 32B in FIG. 32, overlap in four bit positions with any layer in the hierarchy, and 32C overlaps in six bit positions as well. The default mask 32A for example is made of linear segments for odd indexes for plural signals and even indexes for single signal. These default masks do not overlap each other and they can be used inclusively to add their volume. If the default mask 32A and 32B are combined for instance, the resulted bit mask overlaps in eight bit positions with any layer in the hierarchy. To be more specific, for the case where only one layer is available for the L2 filtering, the default mask 32A is coupled to each custom L2 filter for one layer, and the inclusive bit mask of 32B and 32C is used as a default mask at index 0. Then the L4 filter set is assembled with every two L2 filters in the following manner. In the source codes, the members of filter objects include bit mask, ID and Boolean algebra “filled” which indicates whether the bit mask consists entirely of the layers in the hierarchy or any default mask is included in it.

| for( int i =0; i <patternNum; i++) | | |
|---|---|---|
| { | | |
| FilterObj fobj | = | new FilterObj(); |
| int pattern | = | patterns[i]; |
| FilterObj first | = | filterL2[pattern]; |
| FilterObj second | = | filterL2 [pattern\hat{ }first.ID]; |
| fobj.mask | = | first.mask \| second.mask; |
| fobj. ID | = | first.ID \| second.ID; |
| fobj.filled | = | first.filled & second.filled; |
| filterL4[pattern] | = | fobj; |
| } | | |

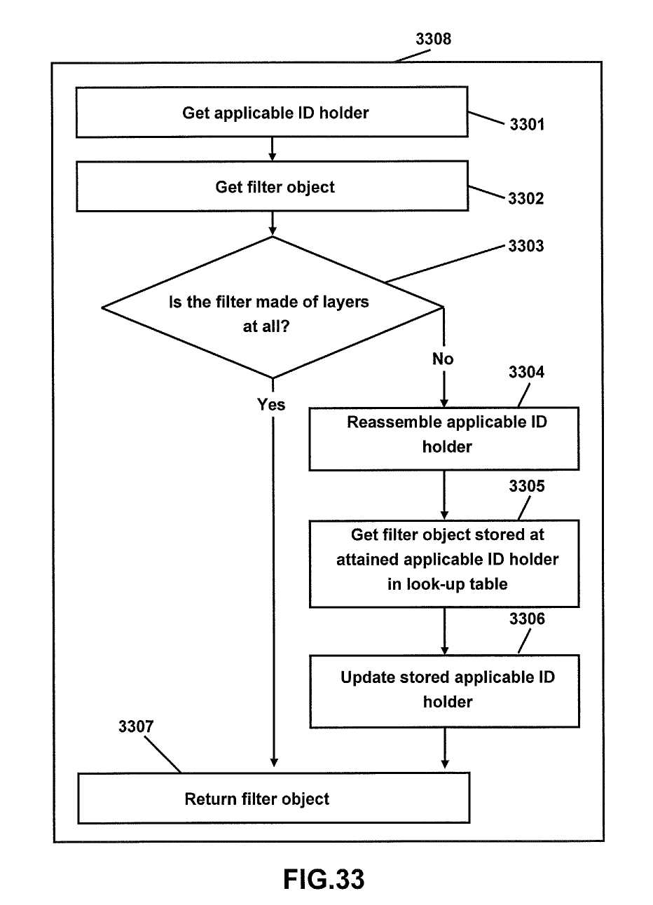

The integer value “pattern” indicates a variation of applicable ID holder. If the pattern includes only one applicable ID, the first L2 filter includes one layer coupled with the default mask 32A, and the second L2 filter is to be the one at index 0 which consists of 32B and 32C. The resulted L4 filter includes one layer and three different default masks. Thus, the layers' volume for the L4 filter is to be maintained. In FIG. 33 indicated is the flowchart to find the next filter to be applied. The stored applicable ID holder is loaded at 3301. The filter inserted at the ID holder's address in the look-up table is selected at 3302. If the filter comprises no default masks, the filter is to be the next filter at 3307. Otherwise the applicable ID holder is reassembled through the monitoring circuit at 3304. The next filter is selected again with the reassembled applicable ID holder at 3305. The stored applicable ID holder is updated to the attained new applicable ID holder at 3306. In this flow, an attempt is made to avoid the use of default masks, but if it is not possible, the introduced default masks will be applied. As to the default mask inserted at index 0, some bits from the signal free area can be added to the mask, which can represent an extra layer beneath the eight layers. On the other hand, it is possible to retrieve the applicable ID holder directly from the monitoring circuit on every occasion of filtering, and if that is the case, the flow in FIG. 33 becomes more simple in such a manner as follows: get the applicable ID holder from the monitoring circuit at 3301; select the filter object at 3302; and return the object at 3307 skipping the rest of the process in FIG. 33. In fact, the improvement in the rendering speed with the stored applicable ID holder may possibly be in indistinguishable level, and the choice from the two methods depends entirely on the purpose and the usage of the transparent filtering.

The introduced default masks do not include the linear segments that belong to the monitoring circuit, and they can be utilized to represent those transparent levels intermediate between two different filter sets such as:
ThiedMemory &=L2filter & ˜defaultMask;
   Thus, the default masks can function as an additional mean to control the transparent levels of rendering objects, which can effect parallelly with the layers' hierarchy as well as with the accumulated volumes of the default masks in different layouts.

How to group filtering objects is set forth now.

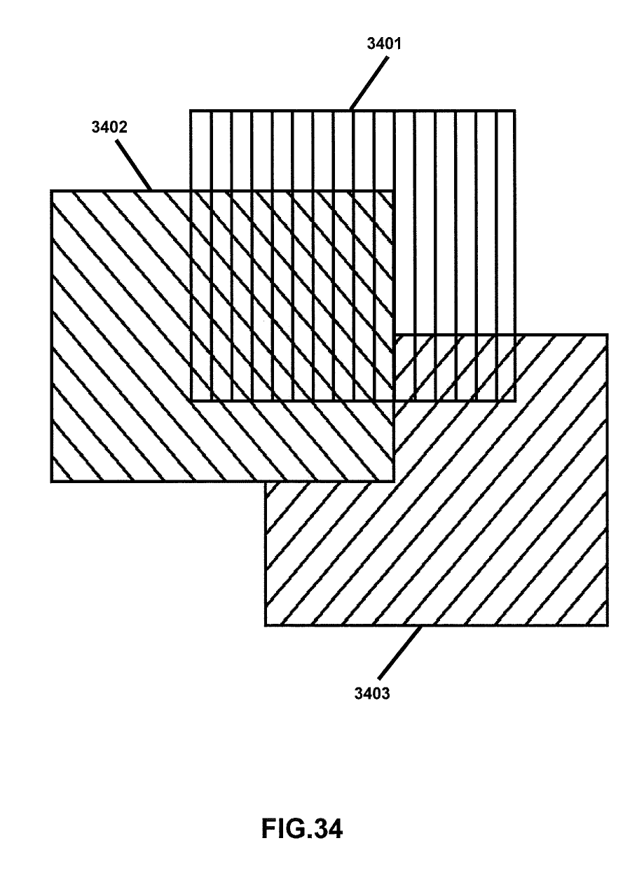

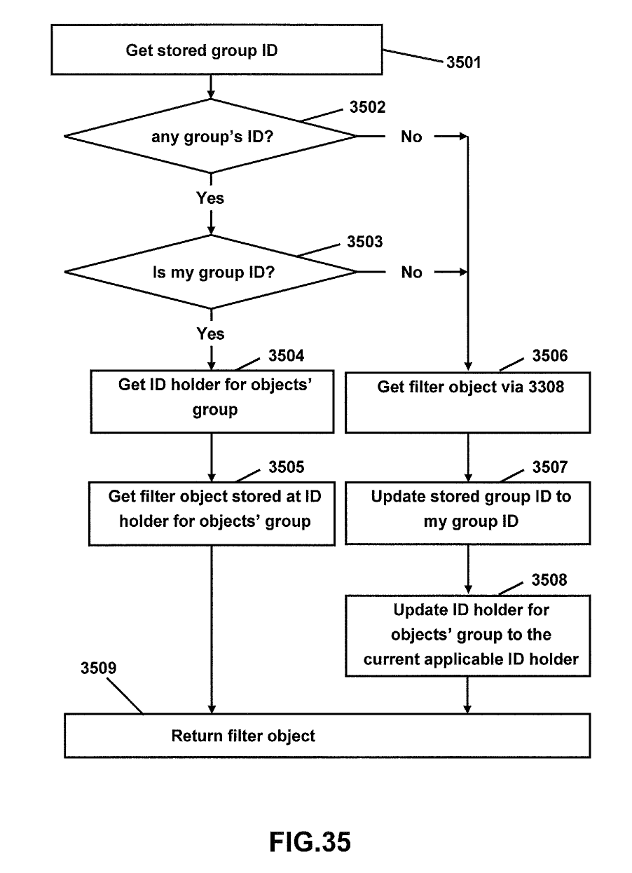

As is discussed, the representation of transparent objects is embodied with the virtual eight layers, and the virtual eight layers themselves are tangible existences of bit masks. This tangibility is a characteristic of the present invention. Those objects being applied the same bit mask do not transmit their appearances each other, and it is possible to make groups of objects sharing the same layer in the hierarchy. Moreover, these grouped transparent objects and usual transparent objects can be exhibited simultaneously in the same frame. FIG. 34 illustrates how the grouped objects function. Three transparent objects are visible in FIG. 34. The object 3401 is a usual transparent object while 3402 and 3403 are grouped transparent objects. The grouped objects, 3402 and 3403, do not transmit their silhouettes each other. When the usual object is behind the other two objects, its appearance is clearly seen by grouping the two objects in the forefront. Thus, the focus amongst the displayed objects can be controlled with three different appearances that include grouped transparent objects, usual transparent objects, and opaque objects. To group transparent objects, two additional memory spaces are provided to store group ID and another ID holder for objects' group. These two memories are updated with the last filtered object holding unknown group ID, and if the group ID stored is identical to the group ID for the rendering object, the next filter is to be selected via the ID holder for objects' group. Since these memories for objects' group are updated on every occasion as filtering a grouped object holding unknown group ID, it is necessary to render the objects' groups in forward to rearward order. In case where the depth order can be irregular, only one group is possible in this method. FIG. 35 shows the flowchart to select filters for grouped objects. The stored group ID is referenced at 3501, and examined whether or not the group ID identifies any particular group of objects at 3502. If the group ID is valid, it is compared to that of the rendering object at 3503, and if the two group IDs coincide, the ID holder for objects' group at 3504 is imported. Then the filter inserted at the ID holder's address is attained at 3505. In case where the group ID given at 3502 is not valid, or the group ID is not for the rendering object at 3503, the next filter is selected via the 3308 procedure at 3506, then the stored group ID is updated to that of the rendering object at 3507. The ID holder for objects' group is also updated to the applicable ID holder at the moment at 3508, and finally, the acquired filter is returned at 3509.

The present invention has been illustrated with respect to a few preferred embodiments, but one of ordinary skill in the art will recognize that deletions, additions, subtractions and improvements can be made while remaining within the spirit and scope of the present invention.

What is claimed is:

1. A method for rendering anti-aliased graphic objects, said method comprising the steps of:
providing first memory to represent blank area in each pixel, having 2^{N} bits of subpixels where N is at least 5, in which memory, ON status bit indicates unstained position in the subpixels' matrix wherein ON and OFF are defined normally 1 and 0, but if alternative setting is preferred, AND operation and OR operation should also be swapped throughout corresponding process, said first memory initialized to be ON status in full;
providing second memory to store accumulation of color values corresponding to said first memory, capable of storing 2^{N} volumes of accumulation of color values reflecting the number of subpixels wherein the amount of stained subpixels in said first memory and the volumes of said accumulation of color values in said second memory synchronize; and
processing scan conversion in forward-to-rearward order, wherein said order is to be determined on either object-by-object basis or pixel-by-pixel basis, comprising:
a step for determining sampling points inside an area to be covered with an intended graphic object;
a step for inverting corresponding subpixels in said first memory to OFF status; and
a step for adding corresponding color values to said second memory by the amount of successfully inverted subpixels in said first memory wherein after all subpixels in a pixel are inverted to OFF status, pixel value for the pixel is to be determined by color values accumulated on said second memory.

2. The method of claim 1, wherein said first memory to be initialized is selected from an updating area(s) in the whole image, and said first memory for outside the updating area(s) is set to be in fully OFF status thereby the updating area(s) is clipped.

3. The method of claim 1, further comprising a step of providing filter objects with which sampling points are filtered, thereby shrinking coverage of rendering objects in respective pixels.

4. The method of claim 3, wherein determining sampling points inside an area to be covered with an intended graphic object comprises a step of filtering sampling points via said filter objects if transparent rendering is desired.

5. The method of claim 4, wherein providing filter objects comprises further steps of:
providing plural layers of bit masks which form a rotational hierarchy in a way where said subpixels are defined as a plurality of signal paths on which ON status positions of each layer move sequentially in accordance with the layers' order wherein lengths of said signal paths are set to be the total number of layers or the factor thereof; and
providing filter objects comprising one or more than one layer(s) from said plural layers wherein the number of layers comprised in each filter object correspond to a desired level of transparency, said filter objects comprising variations of filter objects being characterized in the same transparent level, each corresponding to respective layers in said hierarchy.

6. The method of claim 5, wherein said first memory includes at least two 4×4 regions, said 4×4 regions defined as a set of 4 linear segments respectively, each linear segment consisting of 4 subpixels lined diagonally within a rotational 4×4 matrix, said 4 linear segments in a respective 4×4 region overlapping in no position, sharing the same diagonal line slope.

7. The method of claim 6, wherein an amount of signals i.e. ON status positions for each layer is K=2^{N}/4 indicating each layer's opacity being set at one fourth.

8. The method of claim 7, wherein K/4 signals are distributed uniquely to K/4 signal paths, and 3K/4 signals are distributed substantially uniformly to K/4 signal paths where three signals reside par a path.

9. The method of claim 8, wherein each signal path for three signals is placed on two linear segments in a respective 4×4 region, said two linear segments being adjacent to each other within said rotational 4×4 matrix for a respective 4×4 region.

10. The method of claim 9, wherein said three signals are forming an absolute radian R=π/2+2×tan⁻¹(0.5) in a supposed coordinate space consisting of 2×2 copies of an original 4×4 region where one signal for a peak point is placed on one linear segment and two signals for two end points are placed on the other linear segment.

11. The method of claim 10, wherein intervals in said three signals include two odd intervals, and four path points in even indexes and four path points in odd indexes are separately assigned to either of said two linear segments, wherein the indexes assigned to said two linear segments proceed in the same direction respectively.

12. The method of claim 11, wherein a pair of different sets of signals' intervals is provided for every two signal paths for three signals, wherein intervals whose length include 1, 2, and 3 are assigned to either of said two signal paths, and the number of intervals for each type is identical.

13. The method of claim 12, wherein a positional gap between even indexes and odd indexes in said two linear segments for three signals is determined to form said absolute radian R in accordance with signal intervals being assigned, wherein the radian turns alternatively between positive R and negative R as index proceeds alternating its peak point's position in between said two linear segments for three signals.

14. The method of claim 13, wherein two linear segments in a respective 4×4 region are reserved for signal path for single signal, consisting of mirrored peak points, each of which form a mirrored radian R with corresponding two end points for an original of said radian R formed with said three signals.

15. The method of claim 14, wherein said mirrored radian R turns alternatively in positive and in negative as index proceeds, and four points in even indexes and four points in odd indexes are separately positioned to either of said two linear segments for single signal.

16. The method of claim 15, wherein each signal path for single signal consists of two linear segments from two different 4×4 regions, wherein every two paths for single signal are mapped over every two 4×4 regions, including first and second paths, said second path(s) being reserved as editable area, and assignments of even indexes and odd indexes alternate between said first and second paths in every two 4×4 regions.

17. The method of claim 16, wherein said editable path(s) is/are to be optionally divided into shorter paths whose length are factor(s) of the total number of layers, said shorter paths including signal path for no signal i.e. an area reserved for a background view.

18. The method of claim 17, wherein proceeding directions of signal paths are determined to counterbalance with each other when said subpixels comprise four or more 4×4 regions.

19. The method of claim 18, wherein ID bit for each layer is defined in favor of layout of said first path(s) for single signal wherein those bits on said first path(s) are traveled to align successively in respective bit positions for ID bits via two operations with predetermined values comprising:
multiplier(s) with which corresponding part(s) of those bits on said first path(s) is/are multiplied to form successive bit segment(s) in desired order(s); and
offset value(s) with which said successive bit segment(s) is/are shifted to align in respective bit positions for ID bits.

20. The method of claim 19, wherein yet-to-be-applied layers' IDs for an intended pixel are assembled into a bit array called applicable ID holder, comprising the steps of:
(1) assembling ID bits from said respective first path(s) for single signal via said two operations on said first memory for an intended pixel;
(2) processing AND operation between/among the resultants of (1) when a plurality of said first paths exist; and
(3) processing OR operation between/among the resultants of (1) when the resultant of (2) does not include an expected amount of layer's IDs.

21. The method of claim 20, wherein look-up table(s) is/are provided to identify appropriate layer(s) to be applied to intended pixels, having entries for all possible variations of said applicable ID holder, said look-up table(s) representing priorities' order including:
(1) when partitions exist in applicable layers' order where the layers' order is rotational, selecting a layer(s) designated with ID bit(s) in the smallest partition;
(2) when a plurality of applicable layers are aligned consecutively where the layers' order is rotational, selecting a layer(s) designated with ID bit(s) in the first part of the alignment; and
(3) selecting a layer(s) in accordance with applicable layers' order.

22. The method of claim 21, wherein filtering said sampling points via said filter objects comprises further steps of:
attaining an applicable ID holder for an intended pixel; and
identifying a filter object(s) to be applied to the intended pixel via one from said look-up table(s) with the applicable ID holder.

23. The method of claim 22, wherein attaining an applicable ID holder for an intended pixel via one is done by one of three methods specified as;
(a) attaining said applicable ID holder from said first memory for the intended pixel;
(b) attaining said applicable ID holder from a memory space provided to store applicable ID holder for each pixel wherein said stored applicable ID holder is initialized to include all layers' ID bits, and when any layer is applied, its ID bit is to be inverted, wherein in case where applicable layers indicated in said stored applicable ID holder are not sufficient for desired filtering, said stored applicable ID holder is to be reassembled from said first memory for the intended pixel; and
(c) attaining said applicable ID holder for grouped objects, said ID holder being generated by:
an act for providing group ID for each objects' group designated to share the same layer(s);
an act for providing a memory space for each pixel for storing said group ID and an applicable ID holder for objects' group, wherein said memory space is to be updated with the last filtered object holding an unknown group ID; and
an act for comparing a group ID stored in said memory space with that of a rendering object wherein in case where the group ID stored in said memory space is identical to the group ID for said rendering object, said applicable ID holder stored for objects' group is to be the one for the intended pixel, otherwise an applicable ID holder is attained via said (a) or said (b), thereby updating said memory space with the group ID for the rendering object and the attained applicable ID holder.

24. An apparatus for rendering anti-aliased graphic objects, said apparatus comprising:
a first memory to represent blank area in each pixel, having 2^{N} bits of subpixels where N is at least 5, in which memory, ON status bit indicates unstained position in the subpixels' matrix wherein ON and OFF are defined normally 1 and 0, but if alternative setting is preferred, AND operation and OR operation should also be swapped throughout corresponding process, said first memory initialized to be ON status in full;
a second memory to store accumulation of color values corresponding to said first memory, capable of storing 2^{N} volumes of accumulation of color values reflecting the number of subpixels wherein the amount of stained subpixels in said first memory and the volumes of said accumulation of color values in said second memory synchronize; and
a scanning part in which scan conversion is processed in forward-to-rearward order, wherein said order is to be determined on either object-by-object basis or pixel-by-pixel basis, wherein:
sampling points are to be determined inside an area to be covered with an intended graphic object;
corresponding subpixels in said first memory are to be inverted to OFF status; and
corresponding color values are to be added to said second memory by the amount of successfully inverted subpixels in said first memory wherein after all subpixels in a pixel are inverted to OFF status, pixel value for the pixel is to be determined by color values accumulated on said second memory.

25. The apparatus of claim 24, wherein filter objects are to be provided with which sampling points are filtered, thereby shrinking coverage of rendering objects in respective pixels; and wherein determining sampling points inside an area to be covered with an intended graphic object comprises filtering sampling points via said filter objects if transparent rendering is desired.
